(19) United States
(12) Patent Application Publication
(10) Pub. No.: US 2013/0111677 A1
(43) Pub. Date: May 9, 2013

(54) Concentrated Soak Wash

(71) Applicant: Lillian Eva Tang Baltsen, Bagsvaerd (DK)

(72) Inventor: Lillian Eva Tang Baltsen, Bagsvaerd (DK)

(73) Assignee: NOVOZYMES A/S, Bagsvaerd (DK)

(21) Appl. No.: 13/810,295

(22) PCT Filed: Aug. 22, 2011
(86) PCT No.: PCT/EP11/64357

§ 371 Date: Jan. 15, 2013

(30) Foreign Application Priority Data
Aug. 30, 2010 (EP) 10174516.4
Mar. 31, 2011 (EP) 11160580.4

(51) Int. Cl. C11D 3/386

(52) U.S. Cl. CPC C11D 3/386; C11D 3/38618; C11D 3/38645; C11D 3/38636; C11D 3/38627
USPC 8/137

(57) ABSTRACT

The present invention relates to a method for cleaning an object comprising the steps: (a) distributing to the object a first soak solution comprising at least one surfactant and at least one enzyme followed by a first soak period wherein the concentrations of the at least one surfactant and the at least one enzyme are higher relative to their concentrations in a subsequent wash solution; (b) furthermore adding to the object water to obtain a wash solution followed by a wash period; and (c) rinsing the object; wherein said method has a wash performance corresponding to any of (i) a Relative Wash Performance (RWP) of at least 1; (ii) a Process Related Cleaning Index (PRCI) of more than 1; or (iii) a Relative Wash Performance (RWP) of at least 1 and a Process Related Cleaning Index (PRCI) of more than 1.

### BACKGROUND OF THE INVENTION

1. Field of the Invention

The present invention relates to wash processes for cold water wash. In particular the invention relates to concentrated liquid soak wash processes comprising at least one enzyme and at least one surfactant.

2. Description of the Related Art

In the last decade much effort has been used in the industry to develop detergent compositions suitable for cold wash conditions. Some of the challenges to be faced when the wash temperature is lowered are amongst others that many surfactants are harder to dissolve in cold water and wetting of textile thus becomes more difficult. For those skilled in the art of detergent formulation there is a wide variety of detergent composition components e.g. surfactants available, however the majority of these are specialty chemicals which are not suitable for routine use, in particular not for low cost items such as home laundering products.

Another challenge for developing detergent compositions products for the low temperature area is that the detergent compositions need to perform optimally at both warm and cold wash conditions due to marked expectations. Therefore only chemicals which in their functionality are robust towards a change in temperature will find their way into such products.

Currently available detergent composition products have a higher wash performance at 40° C. as compared to 20° C. and the detergency becomes even worse when the temperature is lowered from 20° C. to 10° C. Thus, so far it has not been possible by chemistry alone to compensate for the decrease in detergency as the wash temperature is lowered.

Certain types of dirt and stains may be difficult to remove in a normal wash process and means of individual stain removal such as pre-spotters have in some cases been applied. However, such treatment involves separate handling of the objects to be cleaned and imposes additional cleaning steps. Examples of boosting or changing currently used wash processes are listed below: WO07/008776 relates to a single-dose enzyme tablet for enhancing and/or supplementing the performance of commercially available fabric and dish care products and providing a cleaning benefit. Such benefit is achieved when using a regular or normal wash temperature and a conventional wash cycle time, the wash performance is improved.

WO08/101958 relates to a method for laundering fabrics, wherein a foam composition comprising enzymes is distributed over fabrics. After a holding period, water and optionally a detergent composition are added and the fabrics are washed under usual washing conditions.

US2008/0276972 relates to a wash cycle for oxidizing agents wherein a first and subsequently a second wash liquor is dispensed into a wash zone. The wash liquors being either detergent wash liquor or oxidizing wash liquor.

The desire to reduce wash temperatures and at the same time maintain at least the same level of wash performance may thus not solely be met or satisfied by exploring how detergent compositions are formulated but rethinking and transformation of current wash processes must also be considered.

The activity of certain detergent composition components is markedly reduced when lowering the temperature and temperature activation at a higher temperature than the wash temperature may be needed.

It would be advantageous in the art to optimize wash processes whereby stain removal may be improved without simultaneously also reducing the cleaning efficiency and particularly in light of the growing desire to reduce the overall energy consumption.

### SUMMARY OF THE INVENTION

The inventors have developed a wash process comprising an initial concentrated surfactant and enzyme soak followed by a main wash and surprisingly found that this concentrated liquid soak wash process shows a significant increase in stain removal on a very broad range of stains and an improved wash performance in general. The use of selected chemistry for detergent compositions in combination with a changed wash process has shown to improve the wash performance for a range of temperatures and in particular at low or cold temperatures. The cleaning efficiency for cold concentrated soak wash processes has been increased to a level that matches the currently used warm wash process.

Many stains need different kinds of cleaning chemistry and process in order to be removed. This gives a dilemma because often many different kinds of soling are gathered in the same wash load. Detergents for a normal wash are formulated as a compromise in respect to cleaning many different stain types in same process at same time.

In normal wash processes the amount of chemicals used may be increased with a simultaneous increase in wash performance. At a certain level, the cost-benefit balance may no longer be favorable or a plateau may even be reached where further stain removal is not observed, or the detergency is even reduced. It would therefore be desirable to optimize the use of the chemicals added. The concentrated soak wash process raises this upper limit and opens for a better wash performance in particular at cold wash conditions. In this wash process currently used chemistry such as commercially available detergents that are formulated with as well as without enzymes may be used and result in increased wash performance.

In a first aspect the invention relates to a method for cleaning an object comprising the steps: (a) distributing to the object a first soak solution comprising at least one surfactant and at least one enzyme followed by a first soak period wherein the concentrations of the at least one surfactant and the at least one enzyme are higher relative to their concentrations in a subsequent wash solution; (b) furthermore adding to the object water to obtain a wash solution followed by a wash period; and (c) rinsing the object; wherein said method has a wash performance corresponding to any of (i) a Relative Wash Performance (RWP) of at least 1; (ii) a Process Related Cleaning Index (PRCI) of more than 1; or (iii) a Relative Wash Performance (RWP) of at least 1 and a Process Related Cleaning Index (PRCI) of more than 1.

In a second aspect the invention relates to use of the method for cleaning laundry.

### DETAILED DESCRIPTION OF THE INVENTION

The invention relates to a novel wash process which in comparison with a normal wash process has improved wash performance and at the same time provides means for washing at low and/or cold temperatures and for using less detergent and water whereby the overall energy consumption can be reduced.

The wash process not only shows an improved cleaning effect in comparison with a normal wash conducted at the same temperature but surprisingly demonstrates an overall wash performance when conducted at 20° C. that match the level of a “normal heavy duty wash” at 40° C. This effect is observed even on stains that normally changes physical state at reduced or cold temperatures such as lard and sebum and other fatty material that harden and crystallize at cold conditions and melt at warmer (40° C. and above) conditions.

There are many benefits of the method described herein. The concentrated liquid soak wash process is characterized by reduced energy consumption as compared to a normal wash process due to the improved detergency power at low temperature. The energy for heating wash water is by far the most energy consuming part of the wash process. Due to the concentrated soak period in which the period with agitation or other mechanical action is low the overall wash time may be cut, the total water consumption is decreased and there is less mechanical wear of the object.

### DEFINITIONS

Benchmark: The terms “Benchmark” or “Benchmark cleaning” in relation to a process of the invention are defined herein as both denoting the cleaning performance resulting from using the same detergent/wash solution as used in the process in question in a normal wash at the same temperature. It is expressed as a delta remission value (see definition below). In the examples the results relating to the benchmark are in most cases shown in column a.

Concentrated soak wash process: The terms “Concentrated soak wash”, “Concentrated soak-wash process”, “2-stage wash process” and “liquid concentrated soak wash” are defined herein as synonyms. The term “liquid” may be included such as in “liquid concentrated soak wash” to emphasize that soaking is performed by applying to the object a solution and not non-liquid compositions such as foam.

Delta remission value (ΔRem): The terms “Delta remission” or “Delta remission value” are defined herein as the result of a reflectance or remission measurement at 460 nm. The swatch is measured with one swatch of similar color as background, preferably a swatch from a repetition wash. A swatch representing each swatch type is measured before wash. The Delta remission is the remission value of the washed swatch minus the remission value of the unwashed swatch.

Enzyme-related Cleaning Index (ERCI): The term “Enzyme-related Cleaning Index” (at a given temperature) is defined herein as the cleaning performance of a wash process in the presence of additional enzyme(s) relative to the cleaning performance of the same wash process at the same temperature and using the same detergent but in the absence of additional enzyme(s), according to the following formula: [ERCI (X° C.)=ΔRem of a wash process with additional enzyme(s) (X° C.)/ΔRem of the same wash process without additional enzyme(s) (X° C.)].

Normal wash process: The terms “Normal wash” or “Normal wash process” are defined herein as a one-step wash process wherein the object is cleaned by submerging the object in a wash solution during agitation followed by rinsing.

Process-related Cleaning Index (PRCI): The term “Process-related Cleaning Index” (at a given temperature) is defined herein as the cleaning performance of the wash process according to the invention at that temperature relative to the cleaning performance of the benchmark. The wash performance of the wash process according to the invention at the given temperature (X° C.) and with the detergent ingredients used is compared to that of a normal wash process conducted at the same temperature (X° C.) and with the same detergent ingredients applied at the same levels in the wash solution, according to the following formula: [PRCI (X° C.)=ΔRem of wash process according to the invention (X° C.)/ΔRem of Normal wash process (X° C.)].

Relative Wash Performance (RWP): The term “Relative Wash Performance” is defined herein as the wash performance of the wash process according to the invention conducted at a given temperature (X° C.) relative to the wash performance of a normal wash process at 40° C. using the same detergent ingredients at the same levels in the wash solution. RWP is calculated according to the following formula: [RWP (X° C.)=ΔRem of wash process according to the invention (X° C.)/ΔRem of Normal wash process (40° C.)].

### Method of the Invention

The present invention relates to a method for cleaning an object comprising the steps: (a) distributing to the object a first soak solution comprising at least one surfactant and at least one enzyme followed by a first soak period wherein the concentrations of the at least one surfactant and the at least one enzyme are higher relative to their concentrations in a subsequent wash solution; (b) furthermore adding to the object water to obtain a wash solution followed by a wash period; and (c) rinsing the object; wherein said method has a wash performance corresponding to any of (i) a Relative Wash Performance (RWP) of at least 1; (ii) a Process Related Cleaning Index (PRCI) of more than 1; or (iii) a Relative Wash Performance (RWP) of at least 1 and a Process Related Cleaning Index (PRCI) of more than 1.

In some embodiments the invention relates to a method, the wherein the object is fabric/textile.

The wash process may be conducted manually or mechanically in a container or any suitable washing device that may accommodate the object to be cleaned and the soak and wash solutions.

### Soak

The object to be cleaned and a soak solution are added to a suitable container or washing device and in a first step the object is soaked in the soak solution. The soak solution is an aqueous solution comprising at least one surfactant and at least one enzyme. The at least one surfactant and the at least one enzyme may be added individually or as a mixture. They may also be added comprised in a fully formulated detergent composition. The at least one enzyme may furthermore be added together with a detergent composition which detergent composition may be formulated with or without enzyme.

The present wash process requires that at least one enzyme is present in the soak solution. In some embodiments there may be at least two, at least three, at least four, at least five, at least six, at least seven, at least eight, at least nine or at least ten enzymes present in the soak solution. Typically a mixture of selected enzymes is used. Selection of enzyme(s) to be included in the soak solution is dependent on the type of stains to be treated. In some embodiments the invention relates to a method, wherein the at least one enzyme is selected from the group consisting of: hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, beta-glucanases, arabinosidases, hyaluronidases, chondroitinases, laccases, and amylases, or any combination thereof.

In other embodiments the invention relates to a method, wherein the at least one enzyme is a mixture comprising or consisting of an amylase, a cellulase, a lipase and a protease.

Hemicellulases: Hemicellulases are the most complex group of non-starch polysaccharides in the plant cell wall. They consist of polymers of xylose, arabinose, galactose, mannose and/or glucose which are often highly branched and connected to other cell wall structures. Hemicellulases of the present invention therefore include enzymes with xylanolytiactivity, arabinolytic activity, galactolytic activity and/or mannolytic activity. The hemi-cellulases of the present invention may for example be selected from xylanases (EC3.2.1.8, EC3.2.1.32, and EC3.2.1.136), xyloglucanases (EC3.2.1.4 and EC3.2.1.151), arabinofuranosidases (EC3.2.1.55), acetylxylan esterases (EC3.1.1.72), glucuronidases (EC3.2.1.31, EC3.2.1.56, EC3.2.1.128 and EC3.2.1.139), glucanohydrolase (EC3.2.1.11, EC3.2.1.83 and EC3.2.1.73), ferulic acid esterases (EC3.1.1.73), coumaric acid esterases (EC3.1.1.73), mannanases (EC3.2.1.25; EC3.2.1.78 and EC3.2.1.101), arabinosidase (EC3.2.1.88), arabinanases (EC3.2.1.99), galactanases (EC 3.2.1.89, EC3.2.1.23 and EC3.2.1.164) and lichenases (EC3.2.1.73). This is, however, not to be considered as an exhausting list.

Mannananase is a preferred hemicellulase in relation to the present invention. Mannanases hydrolyse the biopolymers made up of galactomannans. Mannan containing stains often comprise guar gum and locust bean gum, which are widely used as stabilizers in food and cosmetic products. Suitable mannanases include those of bacterial or fungal origin. Chemically or genetically modified mutants are included. In a preferred embodiment the mannanase is derived from a strain of the genus Bacillus, especially Bacillus sp. 1633 disclosed in positions 31-330 of SEQ ID NO:2 or in SEQ ID NO:5 of WO99/64619 (hereby incorporated by reference) or Bacillus agaradhaerens, for example from the type strain DSM 8721. A suitable commercially available mannanase is Mannaway® produced by Novozymes A/S or Purabrite™ produced by Genencor a Danisco division. Xylanase is a preferred hemicellulase in relation to the present invention. A suitable commercially available xylanase is Pulpzyme® HC (available from Novozymes A/S).

Pectinases: The term pectinase or pectolytic enzyme is intended to include any pectinase enzyme defined according to the art where pectinases are a group of enzymes that catalyze the cleavage of glycosidic linkages. Basically three types of pectolytic enzymes exist: pectinesterase, which only removes methoxyl residues from pectin, a range of depolymerizing enzymes, and protopectinase, which solubilizes protopectin to form pectin (Sakai et al., (1993) Advances in Applied Microbiology vol. 39 pp 213-294). Example of a pectinases or pectolytic enzyme useful in the invention is pectate lyase (EC4.2.2.2 and EC4.2.2.9), polygalacturonase (EC3.2.1.15 and EC3.2.1.67), polymethyl galacturonase, pectin lyase (EC4.2.2.10), galactanases (EC3.2.1.89), arabinanases (EC3.2.1.99) and/or pectin esterases (EC3.1.1.11). Pectinaceous soils or stains may for example be composed of pectate, polygalacturonicacid, and/or pectin which may be esterified to a higher or lower degree. These substrates are common in soils of vegetable origin which may include grass, vegetables such as spinach, beetroot, carrot, tomatoes, fruits such as all types of cherries and berries, peach, apricot, mango, bananas and grapes as well as stains from drinks derived from plant material, such as wine, beer, fruit juices and additionally tomato sauce, jellies or jams without excluding other pectin containing substances.

Suitable pectinolytic enzymes include those described in WO99/27083, WO99/27084, WO00/55309 and WO02/092741. Suitable pectate lyases include those of bacterial or fungal origin. Chemically or genetically modified mutants are included. In a preferred embodiment the pectate lyase is derived from a strain of the genus Bacillus, especially a strain of Bacillus substilis, especially Bacillus subtilis DSM14218 disclosed in SEQ ID NO:2 or a variant thereof disclosed in Example 6 of WO02/092741 (hereby incorporated by reference) or a variant disclosed in WO03/095638 (hereby incorporated by reference). Alternatively the pectate lyase is derived from a strain of Bacillus licheniformis, especially the pectate lyases disclosed as SEQ ID NO:8 in WO99/27083 (hereby incorporated by reference) or variants thereof as described in WO02/06442. Suitable commercially available pectate lyases are Pectaway® or Pectawash® produced by Novozymes A/S.

Amylases: Common starch containing stains may for example comprise rice, potato, cereals, noodles, pasta and porridge, without excluding other starch containing substances. Starch stains may not always be visible to the naked eye but starch stains tend to act as glue for particulate soils in wash solutions. Amylases prevent the buildup of starch deposits which may cause discoloration on fabrics and starch films on dishes. Amylases comprise e.g. alpha-amylases (EC3.2.1.1), beta-amylases (EC3.2.1.2) and/or glucoamylases (EC3.2.1.3) of bacterial or fungal origin. Chemically or genetically modified mutants of such amylases are included in this connection. Alpha-amylases are preferred in relation to the present invention. Relevant alpha-amylases include, for example, α-amylases obtainable from Bacillus species, in particular a special strain of B. licheniformis, described in more detail in GB1296839.

Examples of useful amylases are the variants described in WO94/02597, WO94/18314, WO96/23873, and WO97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444. Further examples of useful amylases are the alpha-amylases derived from Bacillus sp. he AA560 alpha-amylase derived from Bacillus sp. DSM 12649 disclosed as SEQ ID NO:2 in WO00/60060 (hereby incorporated by reference) and the variants of the AA560 alpha-amylase, including the AA560 variant disclosed in Example 7 and 8 (hereby incorporated by reference). Relevant commercially available amylases include Natelase®, Stainzyme®, Duramyl®, Termamyl®, Termamyl™ Ultra, Fungamyl® and BAN® (all available from Novozymes A/S, Bagsvaerd, Denmark), and Rapidase® and Maxamyl® P (available from DSM, Holland) and Purastar®, Purastar OxAm and Powerase™ (available from Danisco A/S). Other useful amylases are CGTases (cyclodextrin glucanotransferases, EC 2.4.1.19), e.g. those obtainable from species of Bacillus, Thermoanaerobactor or Thermoanaerobacterium.

Cellulases: Cellulases are primarily used for textile care, such as removal or reduction of fuzz and pills from cotton fabrics, softening, colour clarification, particulate soil removal, dye transfer inhibition and anti-redeposition of soils on cotton fabrics in the wash. Suitable cellulases include complete cellulases or mono-component endoglucanases of bacterial or fungal origin with anti redeposition effect. Chemically or genetically modified mutants are included. The cellulase may for example be a mono-component or a mixture of mono-component endo-1,4-beta-glucanase often just termed endoglucanases (EC 3.2.1.4). Some xyloglucanases may also have endoglucanases activity and are also considered as suitable cellulases in the present invention. Suitable cellulases are disclosed in U.S. Pat. No. 4,435,307, which discloses fungal cellulases produced from Humicola insolens. Especially suitable cellulases for this invention are cellulases with anti-redeposition effect.

Suitable mono-component endoglucanases may be obtained from one or more of the following species Exidia glandulosa, Crinipellis scabella, Fomes fomentarius, Spongipellis sp., Rhizophlyctis rosea, Rhizomucor pusillus, Phycomyces nitens, and Chaetostylum fresenii, Diplodia gossypina, Microsphaeropsis sp., Ulospora bilgramii, Aureobasidium sp., Macrophomina phaseolina, Ascobolus stictoides, Saccobolus dilutellus, Peziza, Penicillium verruculosum, Penicillium chrysogenum, and Thermomyces verrucosus, Trichoderma reesei aka Hypocrea jecorina, -Diaporthe syngenesia, Colletotrichum lagenanum, Xylaria hypoxylon, Nigrospora sp., Nodulisporum sp., and Poronia punctata, Cylindrocarpon sp., Nectria pinea, Volutella colletotrichoides, Sordaria fimicola, Sordaria macrospora, Thielavia thermophila, Syspastospora boninensis, Cladorrhinum foecundissimum, Chaetomium murorum, Chaetomium virescens, Chaetomium brasiliensis, Chaetomium cunicolorum, Myceliophthora thermophila, Gliocladium catenulatum, Scytalidium thermophila, Acremonium sp Fusarium solani, Fusarium anguioides, Fusarium poae, Fusarium oxysporum ssp. lycopersici, Fusarium oxysporum ssp. passiflora, Humicola nigrescens, Humicola grisea, Fusarium oxysporum, Thielavia terrestris or Humicola insolens. One preferred endoglucanase is disclosed in WO96/29397 as SEQ ID NO:9 (hereby incorporated by reference) or an enzyme with at least 70% identity thereto and variants thereof as disclosed in Example 1 of WO98/12307. Another preferred endoglucanase is disclosed in WO91/017243 (SEQ ID NO:2) or endoglucanases variants as disclosed in WO94/007998.

Endoglucanases with an anti-redeposition effect may be obtained from fungal endoglucanases lacking a carbohydrate-binding module (CBM) from a number of bacterial sources. Some sources are Humicola insolens, Bacillus sp. deposited as DSM 12648, Bacillus sp. KSMS237 deposited as FERM P-16067, Panibacillus polymyxa, and Panibacillus pabuli. Specific anti-redeposition endoglucanase are disclosed in WO91/17244 (hereby incorporated by reference), WO04/053039 SEQ ID NO:2 (hereby incorporated by reference), JP2000210081 position 1 to 824 of SEQ ID NO:1 (hereby incorporated by reference).

Xyloglucanases with an anti-redeposition effect may be obtained from a number of bacterial sources. Some sources are Bacillus licheniformis, Bacillus agaradhaerens, (WO99/02663) Panibacillus polymyxa, and Panibacillus pabuli (WO01/62903). Suitable variants of xyloglucasnes are also described in PCT/EP2009/056875. A commercially available xyloglucanase is Whitezyme® (Novozymes A/S).

Commercially available cellulases include Celluclast® produced from Trichoderma reesei, Celluzyme® produced from Humicola insolens. Commercially available endoglucanases are Carezyme®, Renozyme®, Endolase® and Celluclean® (Novozymes A/S), and KAC-500(B)™ (Kao Corporation) and Clazinase™, Puradax™EG L and Puradax HA (Danisco A/S).

Lipases: Lipase or a lipolytic enzyme provides improved detergency performance on soils that contain fat or oil. Common fat and/or oil containing stains may for example comprise body soils (sebum), lipstick, mayonnaise, mustard, salad dressings, vegetable fat and oil, animal fat (e.g. butter and gravy), wax and mineral oil without excluding other oil and/or fat containing substances. Any lipase suitable for use in alkaline solutions can be used. Suitable lipases include those of bacterial or fungal origin. Chemically or genetically modified mutants of such lipases are included in this connection. The lipase may for example be triacylglycerol lipase (EC3.1.1.3), phospholipase A2 (EC3.1.1.4), Lysophospholipase (EC3.1.1.5), Monoglyceride lipase (EC3.1.1.23), galactolipase (EC3.1.1.26), phospholipase A1 (EC3.1.1.32), Lipoprotein lipase (EC3.1.1.34). Examples of useful lipases include a Humicola lanuginosa lipase, e.g. as described in EP258068 and EP305216; a Rhizomucor miehei lipase, e.g. as described in EP238023 or from H. insolens as described in WO96/13580; a Candida lipase, such as a C. antarctica lipase, e.g. the C. antarctica lipase A or B described in EP214761; a Pseudomonas lipase, such as one of those described in EP721981 (e.g. a lipase obtainable from a Pseudomonas sp. SD705 strain having deposit accession number FERM BP-4772), in PCT/JP96/00426, in PCT/JP96/00454 (e.g. a P. solanacearum lipase), in EP571982 or in WO95/14783 (e.g. a P. mendocina lipase), a P. alcaligenes or P. pseudoalcaligenes lipase, e.g. as described in EP218272, a P. cepacia lipase, e.g. as described in EP331376, a P. stutzeri lipase, e.g. as disclosed in GB1372034, or a P. fluorescens lipase; a Bacillus lipase, e.g. a B. subtilis lipase (Dartois et al. (1993) Biochemica et Biophysica Acta 1131:253-260), a B. stearothermophilus lipase (JP64/744992) and a B. pumilus lipase (WO91/16422). Other examples are lipase variants such as those described in WO92/05249, WO94/01541, EP407225, EP260105, WO95/35381, WO96/00292, WO95/30744, WO94/25578, WO95/14783, WO95/22615, WO97/04079 and WO97/07202. A preferred lipase variant is that of Humicola lanuginosa DSM 4109 as described in WO00/60063. Especially preferred are the variants disclosed in the Example in WO00/60063 with improved first wash performance i.e., T231R+N233R; G91A+D96W+E99K+G263Q+L264A+I265T+G266D+T267A+L269N+R209P+T231R+N233R; N33Q+D96S+T231R+N233R+Q249R; E99N+N101S+T231R+N233R+Q249R; E99N+N101S+T231R+N233R+Q249R.

Suitable commercially available lipases include Lipex®, Lipolase® and Lipolase Ultra®, Lipolex®, Lipoclean® (available from Novozymes A/S), M1 Lipase™ and Lipomax™ (available from Genencor Inc.) and Lipase P “Amano” (available from Amano Pharmaceutical Co. Ltd.). Commercially available cutinases include Lumafast™ from Genencor Inc.

Cutinases: Potentially useful types of lipolytic enzymes include cutinases (EC3.1.1.74), e.g. a cutinase derived from Pseudomonas mendocina as described in WO88/09367, or a cutinase derived from Fusarium solani pisi (described, e.g., in WO90/09446). Due to the lipolytic activity of cutinases they may be effective against the same stains as lipases. Commercially available cutinases include Lumafast™ from Genencor Inc.

Peroxidases/Oxidases: Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO93/24618, WO95/10602, and WO98/15257. Commercially available peroxidases include Guardzyme™ (Novozymes A/S).

Proteases: Proteases are used in the removal of protein containing stains such as blood, dairy products, body soils (sebum), baby formula, mud, grass, eggs and baby food. Any protease suitable for use in alkaline solutions can be used. Suitable proteases include those of animal, vegetable or microbial origin. Microbial origin is preferred. Chemically modified or protein engineered mutants are included. The protease may for example be a metalloprotease (EC3.4.17 or EC3.4.24) or a serine protease (EC3.4.21), preferably an alkaline microbial protease or a trypsin-like protease. Examples of alkaline proteases are subtilisins (EC3.4.21.62), especially those derived from Bacillus, e.g., subtilisin Novo, subtilisin Carlsberg, subtilisin 309, subtilisin 147 and subtilisin 168 (described in WO89/06279). Examples of trypsin-like proteases are trypsin (e.g., of porcine or bovine origin) and the Fusarium protease described in WO89/06270 and WO94/25583. Examples of useful proteases are the variants described in WO92/19729, WO98/20115, WO98/20116, and WO98/34946, especially the variants with substitutions in one or more of the following positions: 27, 36, 57, 76, 87, 97, 101, 104, 120, 123, 167, 170, 194, 206, 218, 222, 224, 235, and 274. Commercially available protease enzymes include Alcalase®, Savinase®, Primase®, Duralase®, Esperase®, and Kannase® (Novozymes A/S), Maxatase®, Maxacal®, Maxapem®, Properase®, Purafect®, Purafect OxP®, FN2™, and FN3™ (Genencor International Inc.).

In some embodiments the invention relates to a method wherein the at least one enzyme may be used in addition to detergent compositions in accordance with the invention at a level from 0.000001% to 10%, from 0.00001% to 5%, from 0.0001% to 2.5%, from 0.001% to 2%, from 0.01% to 1.5%, or from 0.1% to 1% of enzyme protein by weight of the composition.

In some embodiments the invention relates to a method wherein the at least one enzyme may be used in addition to detergent compositions in accordance with the invention at an amount from 0 to 20, from 0.00001 to 10, from 0.0001 to 5, from 0.0001 to 2.5, from 0.001 to 2, from 0.01 to 1, from 0.1 to 0.5 milligram enzyme protein per gram textile.

In some embodiments the invention relates to a method wherein the at least one enzyme may be used in addition to detergent compositions in accordance with the invention at a concentration from 0 to 5000, from 0.001 to 100, from 0.01 to 50, or from 0.1 to 10 milligram enzyme protein per liter soak solution.

If a fully formulated detergent such as a commercially available detergent is used such detergent may already comprise enzymes. These enzymes provided by the detergent should not be included in calculations relating to the amount of added enzyme protein or the at least one enzyme. The least one enzyme may in general be understood as the individual enzyme or it may be the sum of all the individual enzymes added i.e. an enzyme cocktail. In some embodiments the invention relates to a method wherein the level of enzyme protein by weight of the composition relates to the amount of the individual added enzyme of the at least one enzyme added. In other embodiments the invention relates to a method wherein the level of enzyme protein by weight of the composition relates to the amount of all added enzymes of the at least one enzyme added ie. the total amount of added enzyme.

The enzyme based wash performance is the cleaning effect provided by the enzyme and it may be expressed as an Enzyme-related Cleaning Index (ERCI) as defined supra. Example 3-III shows that by adding the same amount of enzymes to the wash processes result in a higher ERCI for the wash process according to some embodiments of the invention in comparison with a normal wash process. In some embodiments the invention relates to a method wherein the ERCI for the 2-stage process is higher than the ERCI for the corresponding normal wash process. The term “corresponding” should be understood as the wash conditions should be as identical as possible such as temperature, total wash time, added detergent components etc. all except the wash process.

The concentrated soak wash process also requires the presence of at least one surfactant. In some embodiments the invention relates to a method, wherein the surfactants present are selected from the groups consisting of: anionic surfactants; cationic surfactants; zwitterionic surfactants; ampholytic nonionic surfactants; or any combinations thereof.

Suitable anionic surfactants are soaps and those containing sulfate or sulfonate groups. Surfactants of the sulfonate type that come into consideration are (C9-C13-alkyl)benzenesulfonates and olefinsulfonates, the latter being understood to be mixtures of alkenesulfonates and hydroxyalkanesulfonates and -disulfonates, as obtained, for example, by sulfonation of C12-C18 monoolefins having a terminally or internally located double bond. Also suitable are (C12-C18)alkanesulfonates and esters of alpha-sulfo fatty acids (ester sulfonates), for example the alpha-sulfonated methyl esters of hydrogenated coconut, palm kernel or tallow fatty acids a alpha-sulfocarboxylic acids resulting from saponification of MES may be used.

Further suitable anionic surfactants are sulfonated fatty acid glycerol esters comprising mono-, di- and tri-esters and mixtures thereof.

Alk(en)yl sulfates to which preference is given are the alkali metal salts and the sodium salts of sulfuric acid monoesters of C12-C18 fatty alcohols, for example from coconut fatty alcohol, tallow fatty alcohol, lauryl, myristyl, cetyl or stearyl alcohol, or of C10-C20 oxo alcohols and sulfuric acid monoesters of secondary alcohols having that chain length. From the point of view of washing technology, special preference is given to C12-C16 alkyl sulfates and C12-C15 alkyl sulfates and also to C14-C15 alkyl sulfates. Suitable anionic surfactants are also alkane-2,3-diylbis(sulfates) that are prepared, for example, in accordance with U.S. Pat. No. 3,234,258 or U.S. Pat. No. 5,075,041.

Also suitable are the sulfuric acid monoesters of straight-chain or branched C7-C21 alcohols ethoxylated with from 1 to 6 mole of ethylene oxide, such as 2-methyl-branched C9-C11 alcohols with, on average, 3.5 mole of ethylene oxide (EO) or C12-C18 fatty alcohols with from 1 to 4 EO. Because of their high foaming characteristics, they are normally used in washing and cleaning compositions only at relatively low levels, for example at levels of from 1% to 5% by weight.

Anionic surfactants may also include diesters, and/or salts of monoesters, of sulfosuccinic acid with C8-C18 fatty alcohol residues or mixtures thereof. Special preference is given to sulfosuccinates in which the fatty alcohol residues have a narrow chain length distribution. It is likewise also possible to use alk(en)yl sulfosuccinates having preferably from 8 to 18 C-atoms in the alk(en)yl chain, or salts thereof.

Further anionic surfactants that come into consideration are fatty acid derivatives of amino acids, for example of methyltaurine (taurides) and/or of methylglycine (sarcosides). Further anionic surfactants that come into consideration are soaps. Saturated fatty acid soaps such as the salts of lauric acid, myristic acid, palmitic acid, stearic acid, hydrogenated erucic acid and behenic acid and soap mixtures derived from natural fatty acids, for example coconut, palm kernel or tallow fatty acids. The anionic surfactants, including the soaps, may be present in the form of their sodium, potassium or ammonium salts and in the form of soluble salts of organic bases such as mono-, di- or triethanolamine. The anionic surfactants may be present in the form of their sodium or potassium salts.

In other embodiments the invention relates to a method, wherein the anionic surfactant is a linear alkylbenzenesulfonate; alpha-olefinsulfonate; alkyl sulfate (fatty alcohol sulfate); alcohol ethoxysulfate; secondary alkanesulfonate; alpha-sulfo fatty acid methyl ester; alkyl- or alkenylsuccinic acid; soap; or any combination thereof.

As non-ionic surfactants, preferably alkoxylated, advantageously ethoxylated and/or propoxylated, especially primary alcohols having from 8 to 18 C-atoms and, on average, from 1 to 12 moles of ethylene oxide (EO) and/or from 1 to 10 moles of propylene oxide (PO) per mole of alcohol are used. Special preference is given to C8-C16 alcohol alkoxylates, advantageously ethoxylated and/or propoxylated C10-C15 alcohol alkoxylates, especially C12-C14 alcohol alkoxylates, having a degree of ethoxylation between 2 and 10, or between 3 and 8, and/or a degree of propoxylation between 1 and 6, or between 1.5 and 5. The alcohol residue may be preferably linear or, especially in the 2-position, methyl-branched, or may comprise a mixture of linear and methyl-branched chains, as are usually present in oxo alcohols. Special preference is given, however, to alcohol ethoxylates derived from linear alcohols of natural origin that contain from 12 to 18 C-atoms, for example coconut, palm and tallow fatty alcohol or oleyl alcohol, and on average from 2 to 8 EO per mole of alcohol. The ethoxylated alcohols include, for example, C12-C14 alcohols with 3 EO or 4 EO, C9-C11 alcohols with 7 EO, C13-C15 alcohols with 3 EO, 5 EO, 7 EO or 8 EO, C12-18 alcohols with 3 EO, 5 EO or 7 EO, mixtures thereof, such as mixtures of C12-C14 alcohol with 3 EO and C12-C18 alcohol with 5 EO. The mentioned degrees of ethoxylation and propoxylation represent statistical averages which, for a specific product, can be a whole number or a fractional number. Preferred alcohol ethoxylates and propoxylates have a restricted homologue distribution (narrow range ethoxylates/propoxylates, NRE/NRP). In addition to those non-ionic surfactants, fatty alcohol ethoxylates having more than 12 EO may also be used. Examples thereof are tallow fatty alcohol ethoxylate with 14 EO, 25 EO, 30 EO or 40 EO.

Also suitable are alkoxylated amines, which are ethoxylated and/or propoxylated, especially primary and secondary amines having from 1 to 18 C-atoms per alkyl chain and, on average, from 1 to 12 moles of ethylene oxide (EO) and/or from 1 to 10 moles of propylene oxide (PO) per mole of amine.

In addition, as further non-ionic surfactants, there may also be used alkyl polyglycosides of the general formula R₁O(G)ₓ, wherein R₁ is a primary straight-chain or methyl-branched (especially methyl-branched in the 2-position) alkyl group having from 8 to 22, preferably from 12 to 18, C-atoms and the symbol ‘G’ indicates a glycose (monosaccharide) unit having 5 or 6 C-atoms; preferably G is glucose. The degree of oligomerisation x, which indicates the average number of glycose units, will generally lie between 1 and 10; x is preferably from 1.2 to 1.4.

A further class of used non-ionic surfactants, which are used either as sole non-ionic surfactant or in combination with other non-ionic surfactants, comprises alkoxylated, preferably ethoxylated or ethoxylated and propoxylated fatty acid alkyl esters, having from 1 to 4 C-atoms in the alkyl chain, especially fatty acid methyl esters, as described, for example, in JP58/217598.

Non-ionic surfactants of the amine oxide type, for example N-(coco alkyl)-N,N-dimethylamine oxide and N-(tallow-alkyl)-N,N-bis(2-hydroxyethyl)amine oxide, and of the fatty acid alkanolamide or ethoxylated fatty acid alkanolamide type may also be suitable.

In some embodiments the invention relates to a method, wherein the non-ionic surfactant is an alcohol ethoxylate; nonylphenol ethoxylate; alkylpolyglycoside; alkyldimethylamineoxide; ethoxylated fatty acid monoethanolamide; fatty acid monoethanolamide; fatty acid (polyhydroxyalkanol)amide; N-acyl-N-alkyl derivatives of glucosamine (“glucamides”); or any combination thereof.

In some embodiments the invention relates to a method wherein the concentration of the at least one surfactant is from 0 to 500, from 0.00001 to 100, from 0.0001 to 50, from 0.0001 to 40, from 0.001 to 30, from 0.01 to 20, from 0.1 to 15, from 1 to 10 milligram per gram textile.

In some embodiments the invention relates to a method, wherein the concentration of the at least one surfactant is from 0 to 50, from 0.0001 to 40, from 0.001 to 30, from 0.01 to 20 from 0.1 to 10, or from 1 to 5 g per L soak solution.

The concentration of the at least one enzyme and the at least one surfactant are higher relative to their concentrations in the subsequent wash solution.

In some embodiments the invention relates to a method, wherein the concentration of the at least one enzyme in the wash solution is obtained by diluting the soak solution with a factor of at least 1, 2, 3, 4, 5, 6, 7, 8, 9, 10, 11, 12, 13, 14, 15, 16, 17, 18, 19 or 20.

In some embodiments the invention relates to a method, wherein the concentration of the at least one surfactant in the wash solution is obtained by diluting the soak solution with a factor of at least 1, 2, 3, 4, 5, 6, 7, 8, 9, 10, 11, 12, 13, 14, 15, 16, 17, 18, 19 or 20.

### Wash

The wash period is characterized by an increased water level and is initiated by addition of water to the soaked material thereby diluting the soak solution. The weight to weight ratio of material to water is increased to a level from 1:3.5 to 1:6.5, from 1:4 to 1:5, or from 1:4 to 1:2.

Agitation or mechanical action similar to a normal wash is applied. It is preferred to use medium to high agitation during the wash period to secure maximum interaction between textile and wash solution. In some embodiments the invention relates to a method, wherein agitation or other mechanical action is applied during the wash period.

This is observed to increase the solubilization of degraded stain material as well as surfactants that are built up on the textile in the former step. A compromise must be made between consumer need for a short wash time and the need for sufficient wash performance. In some embodiments the invention relates to a method, wherein the wash period is from 5 to 120 minutes, from 5 to 90 minutes, from 10 to 60 minutes, from 10 to 30 minutes, from 5 to 20 minutes, from 5 to 15 minutes, or from 10 to 15 minutes.

The concentrated two soak wash process shows in particular improved cleaning effect at reduced temperatures and accordingly, in some embodiments the invention relates to a method, wherein the temperature during the wash period is about 35° C.; about 30° C.; about 25° C.; about 24° C.; about 23° C.; about 22° C.; about 21° C.; about 20° C.; about 19° C.; about 18° C.; about 17° C.; about 16° C.; about 15° C.; about 14° C.; about 13° C.; about 12° C.; about 11° C.; about 10° C.; about 9° C.; about 8° C.; about 7° C.; about 6° C.; or about 5° C. In another embodiment the invention relates to a method, wherein the temperature during the wash period is below 35° C.; below 30° C.; below 25° C.; below 24° C.; below 23° C.; below 22° C.; below 21° C.; below 20° C.; below 19° C.; below 18° C.; below 17° C.; below 16° C.; below 15° C.; below 14° C.; below 13° C.; below 12° C.; below 11° C.; below 10° C.; below 9° C.; below 8° C.; below 7° C.; below 6° C.; or below 5° C.

In some embodiment the invention relates to a method wherein the temperature during the first soak period and/or the second soak period and/or the wash period are selected individually to be similar or different.

### Rinse

Next step is to let the water out and get ready for rinsing the object. The rinse can be done according to the normal rinse method. If a washing device is used then the rinse program present may be used. If a concentrated two soak wash process has been applied wherein the amount of detergent has been reduced then the amount of rinse water needed for sufficient removal of detergent remnants may also be lowered.

### Use

The method may be applied for cleaning objects within the field of home care cleaning as well as in the field of industrial cleaning. In some embodiments the invention is related to use of the method for cleaning fabric and/or textile. In other embodiments the invention is related to use of the method for cleaning laundry.

Use of the method is furthermore an advantage when a reduction in the amount of enzymes and/or detergent is desired. As shown in example 3-II it is possible to reduce the amount of detergent from a level of 100% to a level of at least 90%, at least 80%, at least 70%, at least 60% or at least 50% and thus also to a level of at least 95%, at least 85%, at least 75%, at least 65% or at least 55% in the wash process according to some embodiments of the invention. Example 3-III demonstrate that enzymes added to the wash process according to some embodiments of the invention result in an improved enzyme based cleaning as compared to what is obtained in a normal wash process which is apparent from the Enzyme Related Cleaning Index (ERCI).

The invention is further described by the following examples that should not be construed as limiting the scope of the invention.

### EXAMPLES

### Materials

Chemicals used as buffers and substrates were commercial products of at least reagent grade.

### Detergent and Enzymes

In the detergent compositions tabulated below, surfactants were added in the form of various commercial products with chain length distributions and degrees of ethoxylation as commonly used in the art when formulating laundry detergents. Enzymes were in some cases comprised in the formulated detergent as indicated.

Detergent enzymes of the classes: proteases, amylases, lipases, cellulases, mannanases and pectinases were variously added, each as a commercial formulated liquid or granulated product. The enzymes, all obtained from Novozymes A/S, Denmark, were used in addition to the detergents in the following examples.

### Swatches

The stained swatches used in the following examples were obtained from Center for Testmaterials BV, Vlaardingen, the Netherlands are listed below in Table I. They have been selected to adress stain removal of the most common stains. The swatches may be divided into groups according to the nature of the stain and thus their main sensitivity: Surfactant sensitive stains; enzyme specific sensitive stains like protease, lipase, cellulase, mannanase or amylase; bleach sensitive stains and tracer swatches sensitive to redeposition.

For small scale (Terg-o-tometer, TOM) one of each selected stained swatch were used per wash and ballast up to 20 g of 50% cotton (Wfk 10A) and 50% polyester (Wfk 30A). Swatch size for example 1 is 3.5×3,5 cm and swatch size for example 2 is 5×5 cm.

TABLE I
Stained swatches

| Swatch | Stain | Textile |
|---|---|---|
| CS-61 | Beef fat | Cotton |
| EMPA 118 | Sebum/pigment (CB) | Cotton |
| EMPA 120 | Lard, quartz, iron oxide | Cotton |
| Wft 10D | Pigment, sebum | Cotton |
| Wft 20D | Pigment, sebum | Polycotton |
| Wfk 20MU | Make-up | Polycotton |
| WFK 30D | Sebum/Pigment | Polyester |
| EMPA 101 | Olive oil/carbon black | Cotton |
| EMPA 106 | Mineral oil/carbon black | Cotton |
| Wfk 10TE | Clay | Cotton |
| Wfk 10PPM | Pigment/vegetable oil/milk | Cotton |
| CS-01 | Blood aged | Cotton |
| C-05 | Blood/Milk/Ink | Cotton |
| EMPA 111 | Blood | Cotton |
| EMPA 116 | Blood/milk/ink | Cotton |
| EMPA 117 | Blod/milk/ink | Polycotton |
| EMPA 164 | Grass | Cotton |
| Wfk 10N | Egg/pigment | Cotton |
| CS-20 | Tomato on cotton | Cotton |
| CS-60 | Spaghetti sauce with beef | Cotton |
| EMPA 114 | Red wine | Cotton |
| Wfk 10J | Tea | Cotton |
| Wfk 10U | Curry on cotton | Cotton |
| Wfk 10WB | Blueberry Juice | Cotton |
| CS-28 | Rice starch | Cotton |
| Wfk 10062 | Potato starch/pigment | Cotton |
| CS-27 | Potato starch | Colored cotton |
| C-H097 | Cocoa/oat flakes | Cotton |
| EMPA 112 | Milk/cocoa | Cotton |
| CS-02 | Cocoa | Cotton |
| CS-06 | Salad dressing | Cotton |
| Wfk 10A | — | 100% white cotton |
| | | pre-washed |
| Wfk 30A | — | 100% white polyester |
| | | pre-washed |
| C-S-101 | Blood, Slightly Aged | Cotton |
| wfk 10N | Grass | Cotton |
| C-H097 | Oatflakes and cocoa | Cotton |
| Equest 007KC | Organic Carrot & Potato Baby Food | Cotton |
| 123 KC | Tomato puree | Cotton |
| Equest P01KC | Tangerine | Cotton |
| CS10 | Butterfat with colorant | Cotton |
| Equest DMO | Dirty Motor oil | Cotton |

### Water Hardness

Water hardness of the solutions used in the following experiments was adjusted to 6° dH unless otherwise indicated. The water hardness was adjusted by adding the appropriate amount from the following two stock solutions. (A) Ca/Mg 2:1 6000° dH/L stock solution: Calcium chloride dehydrate 105 g/L+Magnesium chloride dehydrate: 72.6 g/L. Use 1 ml/L=6° dH. (B) 0.535 M Sodium hydrogencarbonate stock solution: 45 g/L corresponds to 9 g in 200 ml. Use 3 ml/L for 6° dH.

### 2-Stage Wash Process in Terg-O-Tometer (TOM)

1. Add detergent and 40 ml 6° dH water into a 100 ml beaker

2. Stir for 2 minutes and optionally add enzymes.

3. Transfer the 40 ml soak solution to a TOM beaker

4. Start the agitation at 70 rpm

5. Sprinkle the swatches into the beaker and secure that they are properly wetted.

6. Add the ballast load and agitate at 70 rpm for 30 seconds

7. Pause for 4 minutes

8. Add 560 ml 6° dH water and agitate at 70 rpm for 30 seconds

9. Change agitation to 120 rpm and wash for 15 minutes

10. Stop the agitation

11. Transfer the wash load from TOM beaker to a sieve and rinse with cold tap water

12. Press the water out by hand and transfer the wash load to a beaker with 1 L of cold tap water

13. Repeat step 12 and press the water out by hand

14. Separate the soil swatches from the ballast load. The soil swatches are transferred to a 5 L beaker with cold tap water under running water. Keep the ballast load separately for the coming inactivation.

15. Set the timer to 5 minutes.

16. Press the water out by hand and place the soiled swatches on a tray covered with a paper. Add another paper on top of the swatches.

17. Let the swatches dry over night and then measure at the Color Eye as described below.

### Normal Wash Process in Terg-O-Tometer (TOM)

1. Add detergent and 600 ml 6° dH water into a TOM beaker

2. Start agitation at 120 rpm and optionally add enzymes to the beaker.

3. Sprinkle the swatches into the beaker and then the ballast load.

4. Time measurement start when the swatches and ballast are added to the beaker.

5. Wash for 20 minutes

6. Stop agitation

7. Transfer the wash load from TOM beaker to a sieve and rinse with cold tap water

8. Press the water out by hand and transfer the wash load to a beaker with 1 L of cold tap water

9. Repeat step 7 and press the water out by hand

10. Separate the soil swatches from the ballast load. The soil swatches are transferred to a 5 L beaker with cold tap water under running water. Keep the ballast load separately for the coming inactivation.

11. Set the timer to 5 minutes.

12. Press the water out by hand and place the soiled swatches on a tray covered with a paper. Add another paper on top of the swatches.

13. Let the swatches dry over night and then measure at the Color Eye as described below.

### Evaluation of Stains

Wash performance is expressed as a delta remission value (ΔRem). After washing and rinsing the swatches were spread out flat and allowed to air dry at room temperature over night. Light reflectance evaluations of the swatches were done using a Macbeth Color Eye 7000 reflectance spectrophotometer with very small aperture. The measurements were made without UV in the incident light and remission at 460 nm was extracted. Measurements were made on unwashed and washed swatches. The test swatch to be measured was placed on top of another swatch of same type and color (twin swatch). Since there was only one swatch of each kind per beaker, a swatch from a replicate wash was used in this way. Remission values for individual swatches were calculated by subtracting the remission value of the unwashed swatch from the remission value of the washed swatch. The total wash performance for each stained swatch set was calculated as the sum of individual ΔRem.

Unless otherwise indicated the washing in the following examples is conducted according to the small scale process in TOM as outlined above. In all experiments below the visible redeposition was detected on tracer swatches and the level of redeposition resulting from the 2-stage wash processes were at equal levels relative to that of a normal wash process.

### Example 1

### Wash with Detergent 1

Detergent 1 is a liquid formulation with a pH around 8.5 and which comprises enzymes. For each wash an amount of 0.333 g detergent composition as listed below were used.

TABLE 1A
Detergent 1 composition

| | content in detergent |
|---|---|
| | composition by weight |
| LAS detergent | (%) of active substance |
| pH 9.0 PH adjusted before wash with NaOH | specified |
| surfactants | |
| linear alkyl(C10-C13)benzenesulfonate, sodium salt | 5.0 |
| total surfactants | 5.0 |
| Water | 95.5 |
| sodium carbonate (anhydrous) | 0.5 |

TABLE 1B
Amount of Surfactant and Enzymes used

| Dose 0.25 g/30 ml | | g per L soak liquor | g per g textile |
|---|---|---|---|
| total surfactants | | 8.3 | 0.012 |
| added enzymes | | mg active enzyme | mg active |
| according to | | protein per L soak | enzyme protein |
| invention | Product | liquor | per g textile |
| protease | Savinase 16 L | 48.0 | 0.0960 |
| amylase | Stainzyme 12.0 L | 22.5 | 0.0450 |
| lipase | Lipex 100 L | 4.9 | 0.0076 |
| cellulase | Celluclean 5.0 T | 7.0 | 0.0140 |

TABLE 1C
ΔRem calculated for swatches washed in Detergent 1.

| Column | 1b | 1c | 1d | 1e |
|---|---|---|---|---|
| Addition of enzyme cocktail | − | + | − | + |
| Temperature | 20° C. | 20° C. | 20° C. | 20° C. |
| Wash process | Normal | Normal | 2-stage | 2-stage |
| Swatch No: | | | | |
| EMPA 116 | 1 | 4 | 10 | 17 |
| EMPA 120 | 1 | 6 | 5 | 9 |
| wfk 10D | 6 | 9 | 12 | 12 |
| wfk 20MU | 15 | 17 | 14 | 14 |
| EMPA 101 | 4 | 7 | 4 | 7 |
| EMPA 106 | 9 | 10 | 9 | 9 |
| wfk 10TE | 8 | 10 | 8 | 7 |
| EMPA 117 | −1 | 2 | 5 | 15 |
| EMPA 118 | 3 | 6 | 0 | 5 |
| EMPA 164 | 2 | 4 | 7 | 9 |
| EMPA 114 | 10 | 10 | 13 | 13 |
| Wfk 10U | 8 | 7 | 7 | 8 |
| CS 20 | 11 | 14 | 16 | 20 |
| CS-28 | 11 | 29 | 17 | 36 |
| Wfk 10062 | 4 | 16 | 7 | 20 |
| EMPA 112 | 9 | 17 | 9 | 19 |
| wfk 10A | −2 | −1 | −2 | −3 |
| wfk 30A | −2 | −1 | −2 | −3 |
| TOTAL | 99 | 164 | 136 | 211 |
| Process Related Cleaning Index (PRCI) | 1.00 | 1.00 | 1.37 | 1.29 |

Column 1b shows the result of a Normal wash at 20° C. with Detergent 1.
Column 1c shows the result of a Normal Wash at 20° C. with Detergent 1 + Enzymes.
Column 1d shows the result of a 2-stage wash at 20° C. with Detergent 1.
Column 1e shows the result of a 2-stage wash at 20° C. with Detergent 1 + Enzymes

### CONCLUSION

The 2-stage wash process provides an improved cleaning in comparison with benchmark irrespective of the absence or the presence of additional enzymes. This is apparent from the Process Related Cleaning Index (PRCI) which is 1.37 in the absence of enzymes and 1.29 in the presence of enzymes respectively.

### Example 2

### Wash with Detergent 2

Detergent 2 is a liquid formulation with a pH around 7.9 to 8.0 which comprises enzymes. For each wash an amount of 0.600 g detergent composition as listed below were used.

TABLE 2A
Detergent 2 composition

| | content in detergent |
|---|---|
| | composition by weight |
| | (%) of active substance |
| | specified |
| surfactants | |
| linear alkylbenzenesulfonate, sodium salt | 3.9 |
| alkylethoxysulfate, sodium salt | 23.1 |
| soap, sodium salt | 3.3 |
| alcohol ethoxylate | 7.2 |
| dodecyldimethylamine oxide | 1.8 |
| total surfactants | 39.3 |
| water | 41.9 |
| ethanol | 2.8 |
| propane-1,2-diol (MPG) | 3.7 |
| 2-aminoethan-1-ol (MEA) | 1.4 |
| 2,2′-oxydi(ethan-1-ol) (DEG) | 2.7 |
| trisodium citrate dihydrate | 4.8 |
| disodium tetraborate pentahydrate (borax) | 0.9 |
| sodium sulfate (anhydrous) | 0.1 |
| sodium chloride | 0.2 |
| diethylenetriaminepentakis(methylene) | 0.3 |
| pentaphosphonic acid (DTMPA), sodium salt | |
| sodium poly(acrylate) | 0.2 |
| poly(oxyethylene) (PEG) | 0.8 |
| 4,4′-bis[(4-anilino-6-morpholino-1,3,5-triazine-2- | 0.1 |
| yl)amino]stilbene-2,2′-disulfonic acid, sodium salt | |
| enzymes | |
| protease | 0.018 |
| amylase | 0.009 |
| cellulase | 0.00045 |
| mannanase | 0.0015 |

TABLE 2B
Amount of Surfactant and Enzymes used

| | | g per L soak liquor | g per g textile |
|---|---|---|---|
| total surfactants | | 5.9 | 0.012 |
| added enzymes | | mg active enzyme | |
| according to | | protein per L soak | mg active enzyme |
| invention | Product | liquor | protein per g textile |
| protease | Savinase 16 L | 48.0 | 0.0960 |
| amylase | Stainzyme 12.0 L | 22.5 | 0.0450 |
| lipase | Lipex 100 L | 1.7 | 0.0025 |
| cellulase | Celluclean 5.0 T | 7.0 | 0.0140 |
| mannanase | Mannaway 4.0 L | 0.9 | 0.0018 |

TABLE 2C
ΔRem calculated for swatches washed in Detergent 2.

| Column | 2a | 2b | 2c | 2d | 2e |
|---|---|---|---|---|---|
| Addition of enzyme cocktail | − | − | + | − | + |
| Temperature | 40° C. | 20° C. | 20° C. | 20° C. | 20° C. |
| Wash process | Normal | Normal | Normal | 2-stage | 2-stage |
| Swatch No: | | | | | |
| CS-61 | 43 | 38 | 38 | 35 | 39 |
| EMPA 120 | 4 | 3 | 3 | 1 | 3 |
| wfk 10D | 18 | 16 | 18 | 20 | 20 |
| wfk 20D | 19 | 16 | 19 | 18 | 21 |
| wfk 20MU | 19 | 18 | 17 | 18 | 18 |
| EMPA 101 | 7 | 5 | 5 | 5 | 5 |
| EMPA 106 | 10 | 9 | 10 | 6 | 9 |
| wfk 10TE | 13 | 13 | 12 | 13 | 14 |
| wfk10PPM | 20 | 10 | 13 | 18 | 27 |
| C-S-01 | 7 | 5 | 5 | 6 | 7 |
| EMPA 117 | 23 | 18 | 16 | 15 | 24 |
| EMPA 164 | 9 | 7 | 7 | 11 | 14 |
| wfk 10N | 35 | 31 | 28 | 30 | 34 |
| EMPA 114 | 18 | 12 | 12 | 12 | 12 |
| wfk 10J | 11 | 7 | 7 | 12 | 13 |
| CS-60 | 24 | 20 | 22 | 21 | 25 |
| CS-28 | 22 | 15 | 22 | 21 | 29 |
| C-H097 | 44 | 37 | 37 | 34 | 41 |
| EMPA 112 | 21 | 15 | 17 | 14 | 21 |
| C-S-06 | 22 | 16 | 16 | 20 | 21 |
| wfk 10A | 2 | 1 | 2 | 3 | 2 |
| wfk 30A | −3 | −4 | −4 | −3 | −4 |
| TOTAL | 387 | 308 | 325 | 330 | 395 |
| Relative Wash Performance | 1.00 | 0.80 | 0.84 | 0.85 | 1.02 |
| (RWP) | | | | | |
| Process Related Cleaning | — | 1.00 | 1.00 | 1.07 | 1.22 |
| Index (PRCI) | | | | | |

Column 2a shows the result of a Normal wash at 40° C. with Detergent 2.
Column 2b shows the result of a Normal wash at 20° C. with Detergent 2.
Column 2c shows the result of a Normal Wash at 20° C. with Detergent 2 + Enzymes.
Column 2d shows the result of a 2-stage wash at 20° C. with Detergent 2.
Column 2e shows the result of a 2-stage wash at 20° C. with Detergent 2 + Enzymes.

### CONCLUSION

The results show that the overall (Total) wash performance of the 2-stage wash process with enzymes at 20° C. (column e) is higher relative to a normal wash at 40° C. (column a). The 2-stage wash process provides an improved cleaning in comparison with benchmark irrespective of the absence or the presence of additional enzymes. This is apparent from the Process Related Cleaning Index (PRCI) which is 1.07 in the absence of enzymes and 1.22 in the presence of enzymes respectively.

### Example 3

### Wash with Detergent 3

Detergent 3 is a liquid formulation with a pH around 8.0 to 8.1 which comprises enzymes. For each wash an amount of 0.750 g detergent composition as listed below were used.

TABLE 3A
Detergent 3 composition

| | content in detergent |
|---|---|
| | composition |
| | by weight (%) |
| | of active substance |
| | specified |
| surfactants | |
| linear alkylbenzenesulfonate, sodium salt | 4.6 |
| alkylethoxysulfate, sodium salt | 13.9 |
| soap, sodium salt | 3.8 |
| alcohol ethoxylate | 7.0 |
| alkyldimethylamine oxide | 2.0 |
| total surfactants | 31.3 |
| water | 49.8 |
| ethanol | 1.7 |
| propane-1,2-diol (MPG) | 2.8 |
| 2-aminoethan-1-ol (MEA) | 1.6 |
| 2,2′-oxydi(ethan-1-ol) (DEG) | 4.1 |
| trisodium citrate dihydrate | 4.1 |
| disodium tetraborate pentahydrate (borax) | 0.9 |
| sodium sulfate (anhydrous) | 0.1 |
| sodium chloride | 0.1 |
| diethylenetriaminepentaacetic acid (DTPA), | 0.3 |
| sodium salt | |
| sodium poly(acrylate) | 0.1 |
| poly(oxyethylene) (PEG) | 0.8 |
| 4,4′-bis[(4-anilino-6-morpholino-1,3,5-triazine-2- | 0.12 |
| yl)amino]stilbene-2,2′-disulfonic acid, sodium salt | |
| 2,2′-[1,1′-biphenyl-4,4′-diylbis(ethene-2,1- | 0.10 |
| diyl]di(benzenesulfonic acid), sodium salt | |
| enzymes | |
| protease | 0.018 |
| amylase | 0.009 |
| cellulase | 0.00045 |
| mannanase | 0.0015 |

TABLE 3B
Amount of Surfactant and Enzymes used

| | | g per L soak liquor | g per g textile |
|---|---|---|---|
| total surfactants | | 5.9 | 0.012 |
| added enzymes | | mg active enzyme | |
| according to | | protein per L soak | mg active enzyme |
| invention | Product | liquor | protein per g textile |
| protease | Savinase 16 L | 48.0 | 0.0960 |
| amylase | Stainzyme 12.0 L | 22.5 | 0.0450 |
| lipase | Lipex 100 L | 1.7 | 0.0025 |
| cellulase | Celluclean 5.0 T | 7.0 | 0.0140 |
| mannanase | Mannaway 4.0 L | 0.9 | 0.0018 |

TABLE 3C
ΔRem calculated for swatches washed in Detergent 3.

| Column | 3a | 3b | 3c | 3d | 3e |
|---|---|---|---|---|---|
| Addition of enzyme cocktail | − | − | + | − | + |
| Temperature | 40° C. | 20° C. | 20° C. | 20° C. | 20° C. |
| Wash process | Normal | Normal | Normal | 2-stage | 2-stage |
| Swatch No: | | | | | |
| CS-61 | 44 | 39 | 39 | 36 | 38 |
| EMPA 120 | 3 | 4 | 3 | 4 | 4 |
| wfk 10D | 18 | 16 | 16 | 21 | 22 |
| wfk 20D | 19 | 17 | 18 | 21 | 23 |
| wfk 20MU | 19 | 19 | 17 | 19 | 18 |
| EMPA 101 | 7 | 4 | 5 | 4 | 6 |
| EMPA 106 | 9 | 9 | 7 | 8 | 7 |
| wfk 10TE | 14 | 12 | 12 | 13 | 13 |
| wfk 10PPM | 23 | 11 | 16 | 19 | 29 |
| C-S-01 | 6 | 5 | 6 | 6 | 7 |
| EMPA 117 | 21 | 16 | 20 | 20 | 25 |
| EMPA 164 | 10 | 7 | 9 | 11 | 15 |
| wfk 10N | 35 | 31 | 31 | 34 | 38 |
| EMPA 114 | 17 | 13 | 13 | 13 | 14 |
| wfk 10J | 10 | 8 | 8 | 14 | 15 |
| CS-60 | 24 | 21 | 23 | 21 | 25 |
| CS-28 | 26 | 16 | 24 | 23 | 30 |
| C-H097 | 42 | 35 | 37 | 34 | 40 |
| EMPA 112 | 22 | 14 | 16 | 17 | 20 |
| C-S-06 | 20 | 15 | 16 | 20 | 20 |
| wfk 10A | 2 | 2 | 2 | 3 | 1 |
| wfk 30A | −5 | −4 | −4 | −3 | −4 |
| TOTAL | 387 | 308 | 335 | 358 | 409 |
| Relative Wash Performance | 1.00 | 0.80 | 0.87 | 0.93 | 1.06 |
| (RWP) | | | | | |
| Process Related Cleaning | — | 1.00 | 1.00 | 1.16 | 1.22 |
| Index (PRCI) | | | | | |

Column 3a shows the result of a Normal wash at 40° C. with Detergent 3.
Column 3b shows the result of a Normal wash at 20° C. with Detergent 3.
Column 3c shows the result of a Normal Wash at 20° C. with Detergent 3 + Enzymes.
Column 3d shows the result of a 2-stage wash at 20° C. with Detergent 3.
Column 3e shows the result of a 2-stage wash at 20° C. with Detergent 3 + Enzymes.

### CONCLUSION

The results show that the overall (Total) wash performance of the 2-stage wash process with enzymes at 20° C. (column e) is higher relative to a normal wash at 40° C. (column a). The 2-stage wash process provides an improved cleaning in comparison with benchmark irrespective of the absence or the presence of additional enzymes. This is apparent from the Process Related Cleaning Index (PRCI) which is 1.16 in the absence of enzymes and 1.22 in the presence of enzymes respectively.

### Example 3-II

### Wash with Different Amounts of Detergent 3

TABLE 3-II B
Amount of Surfactant and Enzymes used

| | | g per L soak liquor | g per g textile |
|---|---|---|---|
| total surfactants | | 2.1 | 0.0042 |
| added enzymes | | mg active enzyme | |
| according to | | protein per L soak | mg active enzyme |
| invention | Product | liquor | protein per g textile |
| protease | Savinase 16 L | 40.1 | 0.0802 |
| amylase | Stainzyme 12.0 L | 7.5 | 0.0150 |
| lipase | Lipex 100 L | 1.08 | 0.0022 |
| cellulase | Celluclean 5.0 T | 2.34 | 0.0047 |
| mannanase | Mannaway 4.0 L | 0.20 | 0.0004 |
| pectate lyase | Xpect | 4.17 | 0.0083 |

TABLE 3-II C
ΔRem calculated for swatches washed in different amounts of Detergent 3.

| | Column | | | | | | |
|---|---|---|---|---|---|---|---|
| | 3-II a | 3-II b | 3-II c | 3-II d | 3-II e | 3-II f | 3-II g |
| Detergent No: | 3 (100%) | 3 (100%) | 3 (90%) | 3 (80%) | 3 (70%) | 3 (60%) | 3 (50%) |
| Addition of enzyme cocktail | − | − | − | − | − | − | − |
| Temperature | 40° C. | 20° C. | 20° C. | 20° C. | 20° C. | 20° C. | 20° C. |
| Wash process | Normal | Normal | Normal | Normal | Normal | Normal | Normal |
| Swatch No: | | | | | | | |
| C-S-101 | 7 | 3 | 3 | 4 | 4 | 2 | 0 |
| wfk 10N | 25 | 21 | 21 | 20 | 17 | 19 | 16 |
| Empa 164 | 7 | 4 | 4 | 5 | 3 | 3 | 2 |
| C-S-06 | 14 | 8 | 9 | 10 | 9 | 8 | 8 |
| C-H097 | 47 | 39 | 40 | 36 | 41 | 34 | 40 |
| Equest 007KC | 34 | 30 | 35 | 26 | 30 | 27 | 24 |
| CS28 | 33 | 19 | 20 | 20 | 19 | 15 | 14 |
| EMPA 112 | 21 | 8 | 6 | 14 | 12 | 13 | 10 |
| 123 KC | 43 | 42 | 40 | 40 | 37 | 36 | 36 |
| 007KC | 11 | 8 | 8 | 8 | 4 | 9 | 7 |
| CS10 | 29 | 26 | 24 | 22 | 23 | 23 | 20 |
| CS-61 | 42 | 34 | 32 | 27 | 28 | 21 | 26 |
| wfk 20D | 20 | 14 | 15 | 11 | 5 | 12 | 10 |
| DMO | 28 | 29 | 27 | 27 | 28 | 26 | 20 |
| Wfk 10 TE | 7 | 5 | 7 | 6 | 8 | 5 | 6 |
| Wfk 10 PPM | 22 | 8 | 9 | 9 | 7 | 6 | 3 |
| Empa 114 | 20 | 14 | 14 | 14 | 14 | 13 | 8 |
| Wfk 10 J | 18 | 14 | 14 | 14 | 13 | 11 | 12 |
| Wfk 10A | −3 | −1 | 0 | 0 | 0 | −1 | −1 |
| Wfk 30A | 0 | 0 | 0 | 0 | −1 | 0 | 0 |
| TOTAL | 424 | 326 | 326 | 310 | 301 | 283 | 263 |
| Relative Wash | 1.00 | 0.77 | 0.77 | 0.73 | 0.71 | 0.67 | 0.62 |
| Performance (RWP) | | | | | | | |
| Process Related | — | 1.00 | 1.00 | 0.95 | 0.92 | 0.87 | 0.81 |
| Cleaning Index (PRCI) | | | | | | | |

| | Column | | | | | |
|---|---|---|---|---|---|---|
| | 3-II h | 3-II i | 3-II j | 3-II k | 3-II l | 3-II m |
| Detergent No: | 3 (100%) | 3 (90%) | 3 (80%) | 3 (70%) | 3 (60%) | 3 (50%) |
| Addition of enzyme cocktail | + | + | + | + | + | + |
| Temperature | 20° C. | 20° C. | 20° C. | 20° C. | 20° C. | 20° C. |
| Wash process | Normal | Normal | Normal | Normal | Normal | Normal |
| Swatch No: | | | | | | |
| C-S-101 | 4 | 4 | 4 | 3 | 5 | 2 |
| wfk 10N | 24 | 24 | 25 | 23 | 23 | 21 |
| Empa 164 | 4 | 3 | 3 | 5 | 3 | 3 |
| C-S-06 | 10 | 9 | 10 | 10 | 11 | 10 |
| C-H097 | 49 | 52 | 50 | 50 | 45 | 42 |
| Equest 007KC | 30 | 32 | 30 | 31 | 30 | 28 |
| CS28 | 27 | 26 | 29 | 28 | 29 | 27 |
| EMPA 112 | 17 | 15 | 15 | 16 | 13 | 15 |
| 123 KC | 42 | 49 | 46 | 45 | 39 | 43 |
| 007KC | 23 | 21 | 17 | 23 | 19 | 16 |
| CS10 | 26 | 26 | 29 | 26 | 22 | 21 |
| CS-61 | 40 | 38 | 40 | 35 | 28 | 25 |
| wfk 20D | 16 | 18 | 17 | 16 | 14 | 12 |
| DMO | 24 | 28 | 27 | 27 | 24 | 25 |
| Wfk 10 TE | 8 | 9 | 8 | 7 | 5 | 9 |
| Wfk 10 PPM | 16 | 13 | 15 | 14 | 12 | 9 |
| Empa 114 | 15 | 15 | 15 | 14 | 14 | 13 |
| Wfk 10 J | 13 | 13 | 13 | 15 | 15 | 14 |
| Wfk 10A | 0 | 0 | −1 | 0 | −1 | −1 |
| Wfk 30A | 0 | 0 | −1 | −1 | −1 | −1 |
| TOTAL | 389 | 394 | 391 | 386 | 349 | 333 |
| Relative Wash | 0.92 | 0.93 | 0.92 | 0.91 | 0.82 | 0.79 |
| Performance (RWP) | | | | | | |
| Process Related | 1.00 | 1.01 | 1.01 | 0.99 | 0.90 | 0.86 |
| Cleaning Index (PRCI) | | | | | | |
| | Column | | | | | |
| | 3-II n | 3-II o | 3-II p | 3-II q | 3-II r | 3-II s |
| Detergent No: | 3 (100%) | 3 (90%) | 3 (80%) | 3 (70%) | 3 (60%) | 3 (50%) |
| Addition of enzyme cocktail | − | − | − | − | − | − |
| Temperature | 20° C. | 20° C. | 20 C | 20° C. | 20° C. | 20° C. |
| Wash process | 2-stage | 2-stage | 2-stage | 2-stage | 2-stage | 2-stage |
| Swatch No: | | | | | | |
| C-S-101 | 0 | 5 | 2 | 3 | 3 | 1 |
| wfk 10N | 20 | 26 | 20 | 19 | 18 | 13 |
| Empa 164 | 6 | 7 | 6 | 6 | 5 | 4 |
| C-S-06 | 11 | 14 | 13 | 12 | 11 | 10 |
| C-H097 | 47 | 43 | 37 | 43 | 34 | 40 |
| Equest 007KC | 33 | 30 | 32 | 32 | 28 | 30 |
| CS28 | 21 | 23 | 22 | 22 | 20 | 20 |
| EMPA 112 | 15 | 10 | 15 | 14 | 11 | 12 |
| 123 KC | 43 | 40 | 37 | 42 | 39 | 37 |
| 007KC | 9 | 9 | 10 | 9 | 8 | 6 |
| CS10 | 24 | 27 | 25 | 26 | 21 | 20 |
| CS-61 | 36 | 37 | 36 | 35 | 33 | 32 |
| wfk 20D | 16 | 15 | 15 | 12 | 11 | 11 |
| DMO | 28 | 29 | 25 | 26 | 25 | 25 |
| Wfk 10 TE | 8 | 9 | 7 | 8 | 7 | 6 |
| Wfk 10 PPM | 12 | 14 | 13 | 11 | 9 | 11 |
| Empa 114 | 14 | 14 | 14 | 14 | 13 | 14 |
| Wfk 10 J | 16 | 16 | 15 | 15 | 16 | 16 |
| Wfk 10A | −1 | −1 | −3 | −1 | −1 | −1 |
| Wfk 30A | −1 | −1 | −1 | −3 | −1 | −1 |
| TOTAL | 355 | 366 | 339 | 347 | 310 | 307 |
| Relative Wash | 0.84 | 0.86 | 0.80 | 0.82 | 0.73 | 0.72 |
| Performance (RWP) | | | | | | |
| Process Related | 1.09 | 1.12 | 1.04 | 1.06 | 0.95 | 0.94 |
| Cleaning Index (PRCI) | | | | | | |
| | Column | | | | | |
| | 3-II t | 3-II u | 3-II v | 3-II w | 3-II x | 3-II y |
| Detergent No: | 3 (100%) | 3 (90%) | 3 (80%) | 3 (70%) | 3 (60%) | 3 (50%) |
| Addition of enzyme cocktail | + | + | + | + | + | + |
| Temperature | 20° C. | 20° C. | 20° C. | 20° C. | 20° C. | 20° C. |
| Wash process | 2-stage | 2-stage | 2-stage | 2-stage | 2-stage | 2-stage |
| Swatch No: | | | | | | |
| C-S-101 | 6 | 6 | 5 | 2 | 4 | 4 |
| wfk 10N | 25 | 22 | 25 | 24 | 24 | 22 |
| Empa 164 | 9 | 8 | 5 | 6 | 7 | 7 |
| C-S-06 | 17 | 16 | 13 | 12 | 13 | 11 |
| C-H097 | 53 | 57 | 48 | 49 | 42 | 48 |
| Equest 007KC | 35 | 38 | 34 | 34 | 35 | 31 |
| CS28 | 29 | 31 | 31 | 31 | 31 | 30 |
| EMPA 112 | 18 | 18 | 17 | 16 | 16 | 16 |
| 123 KC | 49 | 47 | 42 | 44 | 45 | 40 |
| 007KC | 36 | 38 | 32 | 35 | 34 | 31 |
| CS10 | 29 | 32 | 32 | 28 | 29 | 26 |
| CS-61 | 36 | 37 | 37 | 36 | 35 | 35 |
| wfk 20D | 19 | 19 | 18 | 19 | 15 | 14 |
| DMO | 30 | 26 | 28 | 29 | 27 | 25 |
| Wfk 10 TE | 10 | 10 | 9 | 9 | 7 | 10 |
| Wfk 10 PPM | 24 | 23 | 20 | 17 | 17 | 16 |
| Empa 114 | 15 | 15 | 15 | 15 | 15 | 14 |
| Wfk 10 J | 19 | 19 | 19 | 16 | 17 | 17 |
| Wfk 10A | −1 | −1 | −1 | 0 | −1 | −1 |
| Wfk 30A | 0 | 0 | 0 | −1 | −1 | −2 |
| TOTAL | 458 | 460 | 428 | 422 | 411 | 393 |
| Relative Wash | 1.08 | 1.08 | 1.01 | 1.00 | 0.97 | 0.93 |
| Performance (RWP) | | | | | | |
| Process Related | 1.18 | 1.18 | 1.10 | 1.09 | 1.06 | 1.01 |
| Cleaning Index (PRCI) | | | | | | |

Column 3-IIa shows the result of a Normal wash at 40° C. with 100% Detergent 3.
Column 3-IIb shows the result of a Normal wash at 20° C. with 100% Detergent 3.
Column 3-IIc shows the result of a Normal Wash at 20° C. with 90% detergent 3
Column 3-IId shows the result of a Normal Wash at 20° C. with 80% detergent 3.
Column 3-IIe shows the result of a Normal Wash at 20° C. with 70% detergent 3.
Column 3-IIf shows the result of a Normal Wash at 20° C. with 60% detergent 3.
Column 3-IIg shows the result of a Normal Wash at 20° C. with 50% detergent 3
Column 3-IIh shows the result of a Normal Wash at 20° C. with 100% detergent 3 + 2½ dose of Enzyme cocktail.
Column 3-IIi shows the result of a Normal Wash at 20° C. with 90% detergent 3 + 2½ dose of Enzyme cocktail.
Column 3-IIj shows the result of a Normal Wash at 20° C. with 80% detergent 3 + 2½ dose of Enzyme cocktail.
Column 3-IIk shows the result of a Normal Wash at 20° C. with 70% detergent 3 + 2½ dose of Enzyme cocktail.
Column 3-III shows the result of a Normal Wash at 20° C. with 60% detergent 3 + 2½ dose of Enzyme cocktail.
Colum 3-IIm shows the result of a Normal Wash at 20° C. with 50% detergent 3 + 2½ dose of Enzyme cocktail.
Column 3-IIn shows the result of a 2-stage wash at 20° C. with 100% detergent 3.
Column 3-IIo shows the result of a 2-stage wash at 20° C. with 90% detergent 3.
Column 3-IIp shows the result of a 2-stage wash at 20° C. with 80% detergent 3.
Column 3-IIq shows the result of a 2-stage wash at 20° C. with 70% detergent 3.
Column 3-IIr shows the result of a 2-stage wash at 20° C. with 60% detergent 3.
Column 3-IIs shows the result of a 2-stage wash at 20° C. with 50% detergent 3.
Column 3-IIt shows the result of a 2-stage wash at 20° C. with 100% detergent 3 + ½ dose of Enzyme cocktail.
Column 3-IIu shows the result of a 2-stage wash at 20° C. with 90% detergent 3 + 2½ dose of Enzyme cocktail.
Column 3-IIv shows the result of a 2-stage wash at 20° C. with 80% detergent 3 + 2½ dose of Enzyme cocktail.
Column 3-IIw shows the result of a 2-stage wash at 20° C. with 70% detergent 3 + 2½ dose of Enzyme cocktail.
Column 3-IIx shows the result of a 2-stage wash at 20° C. with 60% detergent 3 + 2½ dose of Enzyme cocktail.
Column 3-IIy shows the result of a 2-stage wash at 20° C. with 50% detergent 3 + 2½ dose of Enzyme cocktail.

### CONCLUSION

The results show that the overall (Total) wash performance of the 2-stage wash process with enzymes and a detergent dosage at at least 80% at 20° C. (column t-v) is higher relative to a normal wash at 40° C. (column a). The 2-stage wash process provides improved cleaning in comparison with benchmark in the absence of additional enzymes when the detergent dosage is at least 70% (columns n-q) which is apparent from the Process Related Cleaning Index (PRCI). In the presence of enzymes the 2-stage wash process provides improved cleaning in comparison with benchmark for all detergent dosages tested i.e. at least 50% (columns t-y).

### Example 3-III

### Wash with Detergent 3 and Different Amounts of Enzymes

TABLE 3-III B
Amount of Surfactant and Enzymes used

| | | g per L | g per L | g per L | g per L | g per L | g per L | g per L |
|---|---|---|---|---|---|---|---|---|
| | | soak liquor | soak liquor | soak liquor | soak liquor | soak liquor | soak liquor | soak liquor |
| total surfactants | | 2.1 | 2.1 | 2.1 | 2.1 | 2.1 | 2.1 | 2.1 |
| | | 0.25× dose; | 0.5× dose; | 1.0× dose; | 1.5× dose; | 2.0× dose; | 2.5× xdose; | 3.0× dose; |
| added | | mg active | mg active | mg active | mg active | mg active | mg active | mg active |
| enzymes | | enzyme | enzyme | enzyme | enzyme | enzyme | enzyme | enzyme |
| according | | protein per L | protein per L | protein per L | protein per L | protein per L | protein per L | protein per L |
| to invention | Product | soak liquor | soak liquor | soak liquor | soak liquor | soak liquor | soak liquor | soak liquor |
| protease | Savinase 16 L | 4.0 | 8.0 | 16.0 | 24.1 | 32.1 | 40.1 | 48.1 |
| amylase | Stainzyme 12.0 L | 0.8 | 1.5 | 3.0 | 4.5 | 6.0 | 7.5 | 9.0 |
| lipase | Lipex 100L | 0.11 | 0.22 | 0.43 | 0.65 | 0.86 | 1.08 | 1.29 |
| cellulase | Celluclean 5.0 T | 0.23 | 0.47 | 0.94 | 1.40 | 1.87 | 2.34 | 2.81 |
| mannanase | Mannaway 4.0 L | 0.02 | 0.04 | 0.08 | 0.12 | 0.16 | 0.20 | 0.24 |
| pectate lyase | Xpect | 0.42 | 0.83 | 1.67 | 2.50 | 3.33 | 4.17 | 5.00 |
| | | g per g | g per g | g per g | g per g | g per g | g per g | g per g |
| | | textile | textile | textile | textile | textile | textile | textile |
| total surfactants | | 0.0042 | 0.0042 | 0.0042 | 0.0042 | 0.0042 | 0.0042 | 0.0042 |
| | | 0.25× | 0.5× | 1.0× | 1.5× | 2.0× | 2.5 × | 3.0× |
| | | dose mg | dose mg | dose mg | dose mg | dose mg | dose mg | dose mg |
| | | active | active | active | active | active | active | active |
| added | | enzyme | enzyme | enzyme | enzyme | enzyme | enzyme | enzyme |
| enzymes | | protein | protein | protein | protein | protein | protein | protein |
| according | | per g | per g | per g | per g | per g | per g | per g |
| to invention | Product | textile | textile | textile | textile | textile | textile | textile |
| protease | Savinase 16 L | 0.0080 | 0.0160 | 0.0321 | 0.0481 | 0.0642 | 0.0802 | 0.0963 |
| amylase | Stainzyme 12.0 L | 0.0015 | 0.0030 | 0.0060 | 0.0090 | 0.0120 | 0.0150 | 0.0180 |
| lipase | Lipex 100L | 0.0002 | 0.0004 | 0.0009 | 0.0013 | 0.0017 | 0.0022 | 0.0026 |
| cellulase | Celluclean 5.0 T | 0.0005 | 0.0009 | 0.0019 | 0.0028 | 0.0037 | 0.0047 | 0.0056 |
| mannanase | Mannaway 4.0 L | 0.000005 | 0.0001 | 0.0002 | 0.0002 | 0.0003 | 0.0004 | 0.0005 |
| pectate Lyase | Xpect | 0.0008 | 0.0017 | 0.0033 | 0.0050 | 0.0067 | 0.0083 | 0.0100 |

TABLE 3-III C
ΔRem calculated for swatches washed in Detergent 3 with
different amounts of enzymes.

| Column | 3-III a | 3-III b | 3-III c | 3-III d | 3-III e |
|---|---|---|---|---|---|
| Detergent No: | 3 | 3 | 3 | 3 | 3 |
| Addition of enzyme | — | — | 0.25x | 0.5x | 1.0x |
| cocktail | | | | | |
| Temperature | 40° C. | 20° C. | 20° C. | 20° C. | 20° C. |
| Wash process | Normal | Normal | Normal | Normal | Normal |
| Swatch No: | | | | | |
| C-S-101 | 7 | 4 | 5 | 5 | 7 |
| wfk 10N | 25 | 22 | 24 | 24 | 24 |
| Empa 164 | 7 | 5 | 4 | 3 | 6 |
| C-S-06 | 14 | 11 | 11 | 14 | 10 |
| C-H097 | 47 | 41 | 42 | 47 | 47 |
| Equest 007KC | 34 | 37 | 39 | 39 | 40 |
| CS28 | 33 | 17 | 21 | 21 | 26 |
| EMPA 112 | 21 | 10 | 15 | 12 | 14 |
| 123 KC | 43 | 49 | 50 | 51 | 55 |
| Equest P01KC | 11 | 26 | 24 | 28 | 24 |
| CS10 | 29 | 29 | 32 | 32 | 33 |
| CS-61 | 42 | 37 | 38 | 37 | 37 |
| wfk 20D | 20 | 14 | 15 | 17 | 17 |
| DMO | 28 | 24 | 25 | 24 | 25 |
| Wfk 10 TE | 7 | 5 | 8 | 7 | 6 |
| Wfk 10 PPM | 22 | 11 | 13 | 14 | 14 |
| Empa 114 | 20 | 14 | 14 | 14 | 14 |
| Wfk 10 J | 18 | 15 | 15 | 16 | 16 |
| Wfk 10A | −3 | −1 | −1 | −1 | 0 |
| Wfk 30A | 0 | 0 | 0 | −1 | −2 |
| TOTAL | 424 | 372 | 393 | 404 | 412 |
| Relative Wash | 1.00 | 0.88 | 0.93 | 0.95 | 0.97 |
| Performance (RWP) | | | | | |
| Process Related | — | 1.00 | 1.00 | 1.00 | 1.00 |
| Cleaning Index (PRCI) | | | | | |
| Enzyme Related | — | 1.00 | 1.06 | 1.09 | 1.11 |
| Cleaning Index (ERCI) | | | | | |

| Column | 3-III f | 3-III g | 3-III h | 3-III i |
|---|---|---|---|---|
| Detergent No: | 3 | 3 | 3 | 3 |
| Addition of enzyme | 1.5x | 2.0x | 2.5x | 3.0x |
| cocktail | | | | |
| Temperature | 20° C. | 20° C. | 20° C. | 20° C. |
| Wash process | Normal | Normal | Normal | Normal |
| Swatch No: | | | | |
| C-S-101 | 3 | 5 | 4 | 5 |
| wfk 10N | 23 | 23 | 26 | 24 |
| Empa 164 | 6 | 8 | 7 | 6 |
| C-S-06 | 12 | 10 | 11 | 11 |
| C-H097 | 48 | 47 | 49 | 50 |
| Equest 007KC | 38 | 36 | 38 | 36 |
| CS28 | 27 | 26 | 26 | 26 |
| EMPA 112 | 12 | 17 | 15 | 15 |
| 123 KC | 52 | 52 | 56 | 54 |
| Equest P01KC | 26 | 27 | 30 | 33 |
| CS10 | 36 | 36 | 38 | 38 |
| CS-61 | 38 | 38 | 38 | 39 |
| wfk 20D | 17 | 16 | 17 | 17 |
| DMO | 25 | 28 | 25 | 26 |
| Wfk 10 TE | 6 | 5 | 6 | 5 |
| Wfk 10 PPM | 13 | 14 | 14 | 16 |
| Empa 114 | 14 | 15 | 15 | 15 |
| Wfk 10 J | 16 | 15 | 15 | 16 |
| Wfk 10A | −1 | −1 | 0 | −2 |
| Wfk 30A | −1 | 0 | −1 | −1 |
| TOTAL | 411 | 420 | 429 | 429 |
| Relative Wash | 0.97 | 0.99 | 1.01 | 1.01 |
| Performance (RWP) | | | | |
| Process Related | 1.00 | 1.00 | 1.00 | 1.00 |
| CleaningIndex (PRCI) | | | | |
| Enzyme Related | 1.11 | 1.13 | 1.15 | 1.15 |
| Cleaning Index (ERCI) | | | | |
| Column | 3-III j | 3-III k | 3-III l | 3-III m |
| Detergent No: | 3 | 3 | 3 | 3 |
| Addition of enzyme | — | 0.25x | 0.5x | 1.0x |
| cocktail | | | | |
| Temperature | 20° C. | 20° C. | 20° C. | 20° C. |
| Wash process | 2-stage | 2-stage | 2-stage | 2-stage |
| Swatch No: | | | | |
| C-S-101 | 6 | 4 | 7 | 5 |
| wfk 10N | 23 | 24 | 28 | 26 |
| Empa 164 | 7 | 12 | 12 | 10 |
| C-S-06 | 13 | 17 | 17 | 11 |
| C-H097 | 42 | 48 | 53 | 51 |
| Equest 007KC | 35 | 38 | 38 | 41 |
| CS28 | 24 | 29 | 27 | 31 |
| EMPA 112 | 14 | 16 | 16 | 17 |
| 123 KC | 43 | 49 | 49 | 52 |
| Equest P01KC | 19 | 30 | 29 | 31 |
| CS10 | 30 | 32 | 36 | 37 |
| CS-61 | 36 | 37 | 38 | 36 |
| wfk 20D | 17 | 19 | 20 | 19 |
| DMO | 27 | 27 | 29 | 27 |
| Wfk 10 TE | 8 | 8 | 9 | 8 |
| Wfk 10 PPM | 15 | 19 | 21 | 18 |
| Empa 114 | 14 | 15 | 14 | 15 |
| Wfk 10 J | 19 | 21 | 22 | 21 |
| Wfk 10A | −2 | −1 | −2 | −1 |
| Wfk 30A | −1 | −1 | −1 | −1 |
| TOTAL | 389 | 443 | 461 | 457 |
| Relative Wash | 0.92 | 1.04 | 1.09 | 1.08 |
| Performance (RWP) | | | | |
| Process Related | 1.05 | 1.13 | 1.14 | 1.11 |
| Cleaning Index (PRCI) | | | | |
| Enzyme Related | 1.00 | 1.14 | 1.19 | 1.18 |
| Cleaning Index (ERCI) | | | | |
| Column | 3-III n | 3-III o | 3-III p | 3-III q |
| Detergent No: | 3 | 3 | 3 | 3 |
| Addition of enzyme | 1.5x | 2.0x | 2.5x | 3.0x |
| cocktail | | | | |
| Temperature | 20° C. | 20° C. | 20° C. | 20° C. |
| Wash process | 2-stage | 2-stage | 2-stage | 2-stage |
| Swatch No: | | | | |
| C-S-101 | 7 | 6 | 4 | 6 |
| wfk 10N | 28 | 28 | 30 | 30 |
| Empa 164 | 9 | 8 | 9 | 8 |
| C-S-06 | 16 | 17 | 14 | 15 |
| C-H097 | 50 | 49 | 53 | 49 |
| Equest 007KC | 37 | 40 | 38 | 39 |
| CS28 | 30 | 31 | 31 | 30 |
| EMPA 112 | 17 | 21 | 18 | 18 |
| 123 KC | 50 | 55 | 54 | 59 |
| Equest P01KC | 33 | 32 | 34 | 36 |
| CS10 | 37 | 38 | 39 | 39 |
| CS-61 | 38 | 37 | 39 | 38 |
| wfk 20D | 21 | 22 | 21 | 20 |
| DMO | 26 | 28 | 25 | 29 |
| Wfk 10 TE | 7 | 9 | 9 | 8 |
| Wfk 10 PPM | 20 | 13 | 22 | 26 |
| Empa 114 | 15 | 15 | 11 | 14 |
| Wfk 10 J | 20 | 20 | 20 | 20 |
| Wfk 10A | −1 | −1 | −1 | −1 |
| Wfk 30A | −1 | −1 | −1 | −1 |
| TOTAL | 458 | 466 | 469 | 482 |
| Relative Wash | 1.08 | 1.10 | 1.10 | 1.14 |
| Performance (RWP) | | | | |
| Process Related | 1.11 | 1.11 | 1.09 | 1.12 |
| Cleaning Index (PRCI) | | | | |
| Enzyme Related | 1.18 | 1.20 | 1.21 | 1.24 |
| Cleaning Index (ERCI) | | | | |

Column 3-III a shows the result of a normal wash at 40° C. with Detergent 3.
Column 3-III b shows the result of a Normal wash at 20° C. with Detergent 3.
Column 3-III c shows the result of a Normal Wash at 20° C. with Detergent 3 + ¼ dose of enzyme cocktail.
Column 3-III d shows the result of a Normal Wash at 20° C. with Detergent 3 + ½ dose of enzyme cocktail .
Column 3-III e shows the result of a Normal Wash at 20° C. with Detergent 3 + 1 dose of enzyme cocktail.
Column 3-III f shows the result of a Normal Wash at 20° C. with Detergent 3 + 1½ dose of enzyme cocktail.
Column 3-III g shows the result of a Normal Wash at 20° C. with Detergent 3 + 2 dose of enzyme cocktail.
Column 3-III h shows the result of a Normal Wash at 20° C. with Detergent 3 + 2½ dose of enzyme cocktail.
Column 3-III i shows the result of a Normal Wash at 20° C. with Detergent 3 + 3 dose of enzyme cocktail.
Column 3-III j shows the result of a 2-stage wash at 20° C. with Detergent 3.
Column 3-III k shows the result of a 2-stage wash at 20° C. with Detergent 3 + ¼ dose of Enzyme cocktail.
Column 3-III l shows the result of a 2-stage wash at 20° C. with Detergent 3 + ½ dose of Enzyme cocktail.
Column 3-III m shows the result of a 2-stage wash at 20° C. with Detergent 3 + 1 dose of Enzyme cocktail.
Column 3-III n shows the result of a 2-stage wash at 20° C. with Detergent 3 + 1½ dose of Enzyme cocktail.
Column 3-III o shows the result of a 2-stage wash at 20° C. with Detergent 3 + 2 dose of Enzyme cocktail.
Column 3-III p shows the result of a 2-stage wash at 20° C. with Detergent 3 + 2½ dose of Enzyme cocktail.
Column 3-III q shows the result of a 2-stage wash at 20° C. with Detergent 3 + 3 dose of Enzyme cocktail.

### CONCLUSION

The results show that the overall (Total) wash performance of the 2-stage wash process with enzymes at 20° C. (columns k-q) is higher relative to a normal wash at 40° C. (column a). The Relative Wash Performance (RWP) obtained with the 2-stage wash process increases with increasing amounts of enzymes. The 2-stage wash process provides an improved cleaning in comparison with benchmark irrespective of the absence or the presence of additional enzymes. This is apparent from the Process Related Cleaning Index (PRCI) which is 1.05 (column j) in the absence of enzymes and 1.13 to 1.22 (columns k-q) in the presence of enzymes respectively. The 2-stage wash process provides an improved enzyme based cleaning in comparison with a normal wash at same temperature which is apparent from the Enzyme Related Cleaning Index (ERCI).

### Example 4

### Wash with Detergent 4

Detergent 4 is a liquid formulation with a pH around 8.25 to 8.30 without enzymes. For each wash an amount of 0.580 g detergent composition as listed below were used.

TABLE 4A
Detergent 4 composition

| | content in detergent |
|---|---|
| | composition |
| | by weight (%) |
| | of active substance |
| | specified |
| surfactants | |
| linear alkylbenzenesulfonate, sodium salt | 11.6 |
| alkylethoxysulfate, sodium salt | 5.5 |
| soap, sodium salt | 2.4 |
| alcohol ethoxylate | 12.3 |
| total surfactants | 31.8 |
| water | 59.2 |
| 2,2′,2″-nitrilotri(ethan-1-ol) (TEA) | 1.6 |
| trisodium citrate dihydrate | 2.0 |
| sodium sulfate (anhydrous) | 0.2 |
| sodium chloride | 0.1 |
| diethylenetriaminepentaacetic acid (DTPA), | 0.4 |
| sodium salt | |
| sodium poly(acrylate) | 0.1 |
| poly(oxyethylene) (PEG) | 2.5 |
| silicone oil | 0.1 |
| 4,4′-bis[(4-anilino-6-morpholino-1,3,5-triazine-2- | 0.13 |
| yl)amino]stilbene-2,2′-disulfonic acid, sodium salt | |

TABLE 4B
Amount of Surfactant and Enzymes used

| | | g per L soak liquor | g per g textile |
|---|---|---|---|
| total surfactants | | 4.6 | 0.0092 |
| added enzymes | | mg active enzyme | |
| according to | | protein per L soak | mg active enzyme |
| invention | Product | liquor | protein per g textile |
| protease | Savinase 16 L | 48.0 | 0.096 |
| amylase | Stainzyme 12.0 L | 22.5 | 0.045 |
| lipase | Lipex 100 L | 1.7 | 0.0025 |
| cellulase | Celluclean 5.0 T | 7.0 | 0.014 |
| mannanase | Mannaway 4.0 L | 0.9 | 0.0018 |

TABLE 4C
ΔRem calculated for swatches washed in Detergent 4.

| Column | 4a | 4b | 4c | 4d | 4e |
|---|---|---|---|---|---|
| Addition of enzyme | − | − | + | − | + |
| cocktail | | | | | |
| Temperature | 40° C. | 20° C. | 20° C. | 20° C. | 20° C. |
| Wash process | Normal | Normal | Normal | 2-stage | 2-stage |
| Swatch No: | | | | | |
| CS-61 | 38 | 22 | 29 | 21 | 35 |
| EMPA 120 | 3 | 1 | 3 | 3 | 5 |
| wfk 10D | 16 | 15 | 16 | 19 | 20 |
| wfk 20D | 19 | 17 | 20 | 19 | 24 |
| wfk 20MU | 16 | 17 | 16 | 17 | 17 |
| EMPA 101 | 8 | 4 | 6 | 6 | 5 |
| EMPA 106 | 12 | 7 | 7 | 12 | 9 |
| wfk 10TE | 10 | 10 | 10 | 10 | 12 |
| wfk 10PPM | 3 | 6 | 15 | 5 | 24 |
| C-S-01 | 5 | 4 | 5 | 5 | 6 |
| EMPA 117 | 5 | 5 | 16 | 5 | 17 |
| EMPA 164 | 5 | 4 | 9 | 4 | 14 |
| wfk 10N | 25 | 24 | 33 | 25 | 31 |
| EMPA 114 | 12 | 9 | 10 | 11 | 10 |
| wfk 10J | −1 | −1 | 2 | 1 | 5 |
| CS-60 | 21 | 18 | 23 | 18 | 24 |
| CS-28 | 10 | 10 | 28 | 10 | 28 |
| C-H097 | 25 | 23 | 38 | 30 | 39 |
| EMPA 112 | 10 | 5 | 14 | 9 | 17 |
| C-S-06 | 7 | 6 | 14 | 7 | 22 |
| wfk 10A | 1 | 1 | 2 | 2 | 2 |
| wfk 30A | −5 | −5 | −5 | −4 | −4 |
| TOTAL | 243 | 201 | 311 | 235 | 360 |
| Relative Wash | 1.00 | 0.83 | 1.28 | 0.97 | 1.48 |
| Performance (RWP) | | | | | |
| Process Related Cleaning | — | 1.00 | 1.00 | 1.17 | 1.16 |
| Index (PRCI) | | | | | |

| Column | 4f | 4g | 4h | 4i |
|---|---|---|---|---|
| Addition of enzyme | − | + | − | + |
| cocktail | | | | |
| Temperature | 15° C. | 15° C. | 15° C. | 15° C. |
| Wash process | Normal | Normal | 2-stage | 2-stage |
| Swatch No: | | | | |
| CS-61 | 20 | 24 | 21 | 24 |
| EMPA 120 | 2 | 4 | 6 | 5 |
| wfk 10D | 15 | 16 | 17 | 19 |
| wfk 20D | 15 | 19 | 16 | 21 |
| wfk 20MU | 15 | 15 | 15 | 16 |
| EMPA 101 | 4 | 4 | 3 | 5 |
| EMPA 106 | 5 | 6 | 6 | 5 |
| wfk 10TE | 10 | 10 | 10 | 11 |
| wfk 10PPM | 3 | 11 | 4 | 17 |
| C-S-01 | 5 | 5 | 5 | 7 |
| EMPA 117 | 7 | 6 | 4 | 11 |
| EMPA 164 | 4 | 5 | 3 | 8 |
| wfk 10N | 17 | 18 | 20 | 26 |
| EMPA 114 | 5 | 5 | 5 | 6 |
| wfk 10J | 0 | 0 | 1 | 1 |
| CS-60 | 17 | 20 | 18 | 21 |
| CS-28 | 12 | 13 | 8 | 23 |
| C-H097 | 28 | 38 | 33 | 42 |
| EMPA 112 | 9 | 11 | 10 | 15 |
| C-S-06 | 6 | 15 | 6 | 21 |
| wfk 10A | −1 | −2 | −1 | −1 |
| wfk 30A | −1 | −2 | −1 | −2 |
| TOTAL | 197 | 242 | 209 | 303 |
| Relative Wash | 0.81 | 1.00 | 0.86 | 1.25 |
| Performance (RWP) | | | | |
| Process Related Cleaning | 1.00 | 1.00 | 1.06 | 1.25 |
| Index (PRCI) | | | | |
| Column | 4j | 4k | 4l | 4m |
| Addition of enzyme | − | + | − | + |
| cocktail | | | | |
| Temperature | 10° C. | 10° C. | 10° C. | 10° C. |
| Wash process | Normal | Normal | 2-stage | 2-stage |
| Swatch No: | | | | |
| CS-61 | 15 | 15 | 18 | 19 |
| EMPA 120 | 3 | 4 | 4 | 5 |
| wfk 10D | 14 | 14 | 15 | 20 |
| wfk 20D | 16 | 17 | 17 | 19 |
| wfk 20MU | 16 | 16 | 16 | 15 |
| EMPA 101 | 4 | 3 | 3 | 4 |
| EMPA 106 | 7 | 6 | 7 | 5 |
| wfk 10TE | 10 | 10 | 11 | 12 |
| wfk 10PPM | 4 | 6 | 5 | 16 |
| C-S-01 | 4 | 3 | 3 | 5 |
| EMPA 117 | 4 | 7 | 4 | 10 |
| EMPA 164 | 4 | 5 | 3 | 8 |
| wfk 10N | 16 | 18 | 18 | 25 |
| EMPA 114 | 5 | 5 | 5 | 6 |
| wfk 10J | −1 | −1 | 1 | 2 |
| CS-60 | 18 | 19 | 17 | 22 |
| CS-28 | 9 | 13 | 7 | 22 |
| C-H097 | 28 | 31 | 30 | 40 |
| EMPA 112 | 9 | 10 | 10 | 13 |
| C-S-06 | 4 | 8 | 5 | 19 |
| wfk 10A | −1 | −1 | −2 | −1 |
| wfk 30A | 0 | −1 | −1 | −1 |
| TOTAL | 188 | 208 | 197 | 286 |
| Relative Wash | 0.77 | 0.86 | 0.81 | 1.18 |
| Performance (RWP) | | | | |
| Process Related Cleaning | 1.00 | 1.00 | 1.05 | 1.38 |
| Index (PRCI) | | | | |

Column 4a shows the result of a Normal wash at 40° C. with Detergent 4.
Column 4b shows the result of a Normal wash at 20° C. with Detergent 4.
Column 4c shows the result of a Normal Wash at 20° C. with Detergent 4 + Enzymes.
Column 4d shows the result of a 2-stage wash at 20° C. with Detergent 4.
Column 4e shows the result of a 2-stage wash at 20° C. with Detergent 4 + Enzymes.
Column 4f shows the result of a Normal wash at 15° C. with Detergent 4
Column 4g shows the result of a Normal wash at 15° C. with Detergent 4 + Enzymes.
Column 4h shows the result of a 2-stage wash at 15° C. with Detergent 4
Column 4i shows the result of a 2-stage wash at 15° C. with Detergent 4 + Enzymes.
Column 4j shows the result of a Normal wash at 10° C. with Detergent 4
Column 4k shows the result of a Normal wash at 10° C. with Detergent 4 + Enzymes
Column 4l shows the result of a 2-stage wash at 10° C. with Detergent 4
Column 4m shows the result of a 2-stage wash at 10° C. with Detergent 4 + Enzymes

### CONCLUSION

The results show that the overall (Total) wash performance of the 2-stage wash process with enzymes at 20° C. (column e), 15° C. (column i) and 10° C. (column m) is higher relative to a normal wash at 40° C. (column a). The 2-stage wash process provides an improved cleaning in comparison with benchmark irrespective of the absence or the presence of additional enzymes. This is apparent from the Process Related Cleaning Index (PRCI) which is 1.17 and 1.16 at 20° C., 1.06 and 1.25 at 15° C., and 1.05 and 1.38 at 10° C. in the absence and presence of enzymes respectively.

### Example 5

### Wash with Detergent 5

Detergent 5 is a liquid formulation with a pH around 10.7 to 11.1 without enzymes. For each wash an amount of 0.610 g detergent composition as listed below were used.

TABLE 5A
Detergent 5 composition

| | content in detergent |
|---|---|
| | composition |
| | by weight (%) |
| | of active substance |
| | specified |
| surfactants | |
| alkylethoxysulfate, sodium salt | 9.6 |
| alcohol ethoxylate | 4.3 |
| total surfactants | 13.9 |
| water | 81.5 |
| sodium chloride | 2.2 |
| sodium poly(acrylate) | 0.4 |
| 4,4′-bis[(4-anilino-6-morpholino-1,3,5-triazine-2- | 0.1 |
| yl)amino]stilbene-2,2′-disulfonic acid, sodium salt | |
| enzymes | |
| protease | 0.018 |
| amylase | 0.009 |

TABLE 5B
Amount of Surfactant and Enzymes used

| | | g per L | g per g |
|---|---|---|---|
| | | soak liquor | textile |
| total surfactants | | 2.1 | 0.0042 |
| | | mg active | mg active |
| added enzymes | | enzyme | enzyme |
| according to | | protein per L | protein per |
| invention | Product | soak liquor | g textile |
| protease | Savinase 16 L | 48.0 | 0.0960 |
| amylase | Stainzyme 12.0 L | 22.5 | 0.0450 |
| lipase | Lipex 100 L | 1.7 | 0.0025 |
| cellulase | Celluclean 5.0 T | 7.0 | 0.0140 |
| mannanase | Mannaway 4.0 L | 0.9 | 0.0018 |

TABLE 5C
ΔRem calculated for swatches washed in Detergent 5.

| | Column | | | | |
|---|---|---|---|---|---|
| | 5a | 5b | 5c | 5d | 5e |
| Addition of enzyme | − | − | + | − | + |
| cocktail | | | | | |
| Temperature | 40° C. | 20° C. | 20° C. | 20° C. | 20° C. |
| Wash process | Normal | Normal | Normal | 2-stage | 2-stage |
| Swatch No: | | | | | |
| CS-61 | 35 | 21 | 17 | 19 | 21 |
| EMPA 120 | 0 | 1 | 2 | 2 | 5 |
| wfk 10D | 15 | 16 | 16 | 14 | 18 |
| wfk 20D | 15 | 12 | 17 | 12 | 18 |
| wfk 20MU | 16 | 15 | 14 | 16 | 16 |
| EMPA 101 | 7 | 4 | 4 | 5 | 5 |
| EMPA 106 | 11 | 7 | 10 | 10 | 10 |
| wfk 10TE | 9 | 10 | 10 | 11 | 12 |
| wfk 10PPM | 4 | 4 | 13 | 4 | 23 |
| C-S-01 | 5 | 5 | 5 | 4 | 8 |
| EMPA 117 | 5 | 5 | 16 | 5 | 20 |
| EMPA 164 | 4 | 5 | 8 | 2 | 11 |
| wfk 10N | 22 | 20 | 26 | 24 | 27 |
| EMPA 114 | 13 | 9 | 10 | 11 | 11 |
| wfk 10J | 0 | 2 | 4 | 2 | 3 |
| CS-60 | 20 | 18 | 22 | 18 | 25 |
| CS-28 | 11 | 9 | 28 | 9 | 28 |
| C-H097 | 26 | 22 | 38 | 28 | 35 |
| EMPA 112 | 5 | 9 | 16 | 5 | 18 |
| C-S-06 | 7 | 4 | 15 | 5 | 20 |
| wfk 10A | 1 | 1 | 2 | 2 | 2 |
| wfk 30A | −6 | −5 | −5 | −4 | −4 |
| TOTAL | 228 | 192 | 289 | 204 | 330 |
| Relative Wash | 1.00 | 0.84 | 1.27 | 0.89 | 1.45 |
| Performance (RWP) | | | | | |
| Process Related | — | 1.00 | 1.00 | 1.06 | 1.14 |
| Cleaning Index (PRCI) | | | | | |

Column 5a shows the result of a normal wash at 40° C. with Detergent 5.
Column 5b shows the result of a Normal wash at 20° C. with Detergent 5.
Column 5c shows the result of a Normal Wash at 20° C. with Detergent 5 + Enzymes.
Column 5d shows the result of a 2-stage wash at 20° C. with Detergent 5.
Column 5e shows the result of a 2-stage wash at 20° C. with Detergent 5 + Enzymes.

### CONCLUSION

The results show that the overall (Total) wash performance of the 2-stage wash process with enzymes at 20° C. (column e) is higher relative to a normal wash at 40° C. (column a). The 2-stage wash process provides an improved cleaning in comparison with benchmark irrespective of the absence or the presence of additional enzymes. This is apparent from the Process Related Cleaning Index (PRCI) which is 1.06 in the absence of enzymes and 1.14 in the presence of enzymes respectively.

### Example 6

### Wash with Detergent 6

Detergent 6 is a powder formulation with a pH around 11.0 to 11.5 without enzymes but with bleach (percarbonate). For each wash an amount of 1.290 g detergent composition as listed below were used.

TABLE 6A
Detergent 6 composition

| | content in detergent |
|---|---|
| | composition by weight |
| | (%) of active substance |
| | specified |
| surfactants | |
| alkylsulfate, sodium salt | 6.4 |
| alcoholethoxylate | 0.9 |
| total surfactants | 7.3 |
| sodium carbonate (anhydrous) | 71.5 |
| sodium hydrogencarbonate | 3.0 |
| sodium silicate | 1.6 |
| sodium triphosphate | 1.3 |
| sodium chloride | 2.1 |
| sodium sulfate (anhydrous) | 1.8 |
| sodium percarbonate | 3.0 |
| sodium poly(acrylate) | 0.4 |
| 4,4′-bis[(4-anilino-6- | 0.04 |
| morpholino-1,3,5-triazine-2- | |
| yl)amino]stilbene-2,2′- | |
| disulfonic acid, sodium salt | |
| enzymes | |
| protease | 0.018 |
| amylase | 0.009 |

TABLE 6B
Amount of Surfactant and Enzymes used

| | | g per L | g per g |
|---|---|---|---|
| | | soak liquor | textile |
| total surfactants | | 2.4 | 0.0047 |
| | | mg active | mg active |
| added enzymes | | enzyme | enzyme |
| according to | | protein per L | protein per |
| invention | Product | soak liquor | g textile |
| protease | Savinase 16 L | 48.0 | 0.0960 |
| amylase | Stainzyme 12.0 L | 22.5 | 0.0450 |
| lipase | Lipex 100 L | 1.7 | 0.0025 |
| cellulase | Celluclean 5.0 T | 7.0 | 0.0140 |
| mannanase | Mannaway 4.0 L | 0.9 | 0.0018 |

TABLE 6C
ΔRem calculated for swatches washed in Detergent 6.

| | Column | | | | |
|---|---|---|---|---|---|
| | 6a | 6b | 6c | 6d | 6e |
| Addition of enzyme | − | − | + | − | + |
| cocktail | | | | | |
| Temperature | 40° C. | 20° C. | 20° C. | 20° C. | 20° C. |
| Wash process | Normal | Normal | Normal | 2-stage | 2-stage |
| Swatch No: | | | | | |
| CS-61 | 34 | 19 | 20 | 22 | 22 |
| EMPA 120 | 7 | 6 | 6 | 17 | 20 |
| wfk 10D | 18 | 16 | 17 | 17 | 18 |
| wfk 20D | 14 | 12 | 14 | 17 | 18 |
| wfk 20MU | 17 | 14 | 16 | 17 | 19 |
| EMPA 101 | 11 | 6 | 7 | 7 | 9 |
| EMPA 106 | 10 | 10 | 10 | 9 | 9 |
| wfk 10TE | 12 | 11 | 12 | 11 | 12 |
| wfk 10PPM | 30 | 22 | 26 | 19 | 18 |
| C-S-01 | 35 | 37 | 41 | 39 | 42 |
| EMPA 117 | 30 | 12 | 34 | 9 | 32 |
| EMPA 164 | 7 | 4 | 9 | 6 | 14 |
| wfk 10N | 36 | 31 | 37 | 29 | 40 |
| EMPA 114 | 0 | 0 | 2 | 4 | 2 |
| wfk 10J | −8 | −10 | −8 | −7 | −10 |
| CS-60 | 21 | 22 | 22 | 23 | 26 |
| CS-28 | 9 | 18 | 19 | 17 | 26 |
| C-H097 | 34 | 42 | 42 | 37 | 44 |
| EMPA 112 | 16 | 19 | 22 | 19 | 21 |
| C-S-06 | 9 | 9 | 14 | 10 | 15 |
| wfk 10A | 0 | 1 | 1 | 1 | 1 |
| wfk 30A | −5 | −6 | −4 | −4 | −5 |
| TOTAL | 336 | 294 | 359 | 318 | 393 |
| Relative Wash | 1.00 | 0.88 | 1.07 | 0.95 | 1.17 |
| Performance (RWP) | | | | | |
| Process Related | — | 1.00 | 1.00 | 1.08 | 1.09 |
| Cleaning Index (PRCI) | | | | | |

Column 6a shows the result of a normal wash at 40° C. with Detergent 6.
Column 6b shows the result of a Normal wash at 20° C. with Detergent 6.
Column 6c shows the result of a Normal Wash at 20° C. with Detergent 6 + Enzymes.
Column 6d shows the result of a 2-stage wash at 20° C. with Detergent 6.
Column 6e shows the result of a 2-stage wash at 20° C. with Detergent 6 + Enzymes.

### CONCLUSION

The results show that the overall (Total) wash performance of the 2-stage wash process with enzymes at 20° C. (column e) is higher relative to a normal wash at 40° C. (column a). The 2-stage wash process provides an improved cleaning in comparison with benchmark irrespective of the absence or the presence of additional enzymes. This is apparent from the Process Related Cleaning Index (PRCI) which is 1.08 in the absence of enzymes and 1.09 in the presence of enzymes respectively.

### Example 7

### Wash with Detergent 7

Detergent 7 is a liquid formulation with a pH around 8.0 to 8.2 with enzymes. For each wash an amount of 0.580 g detergent composition as listed below were used.

TABLE 7A
Detergent 7 composition

| | content in detergent |
|---|---|
| | composition by weight |
| | (%) of active substance |
| | specified |
| surfactants | |
| linear alkylbenzenesulfonate, sodium salt | 1.9 |
| alkylethoxysulfate, sodium salt | 10.5 |
| soap, sodium salt | 2.0 |
| alcohol ethoxylate | 5.1 |
| alkyltrimethylammonium chloride | 1.8 |
| total surfactants | 21.3 |
| water | 66.3 |
| ethanol | 1.5 |
| propane-1,2-diol (MPG) | 2.0 |
| 2-aminoethan-1-ol (MEA) | 0.6 |
| 2,2′-oxydi(ethan-1-ol) (DEG) | 4.0 |
| sodium toluenesulfonate | 0.4 |
| trisodium citrate dihydrate | 2.3 |
| disodium tetraborate pentahydrate (borax) | 0.9 |
| sodium sulfate (anhydrous) | 0.1 |
| diethylenetriaminepentaacetic acid (DTPA), | 0.2 |
| sodium salt | |
| sodium poly(acrylate) | 0.1 |
| 4,4′-bis[(4-anilino-6-morpholino-1,3,5- | 0.1 |
| triazine-2-yl)amino]stilbene-2,2′-disulfonic | |
| acid, sodium salt | |
| enzymes | |
| protease | 0.018 |
| amylase | 0.009 |

TABLE 7B
Amount of Surfactant and Enzymes used

| | | g per L | g per g |
|---|---|---|---|
| | | soak liquor | textile |
| total surfactants | | 3.1 | 0.0062 |
| | | mg active | mg active |
| added enzymes | | enzyme | enzyme |
| according to | | protein per L | protein per |
| invention | Product | soak liquor | g textile |
| protease | Savinase 16 L | 48.0 | 0.0960 |
| amylase | Stainzyme 12.0 L | 22.5 | 0.0450 |
| lipase | Lipex 100 L | 1.7 | 0.0025 |
| cellulase | Celluclean 5.0 T | 7.0 | 0.0140 |
| mannanase | Mannaway 4.0 L | 0.9 | 0.0018 |

TABLE 7C
ΔRem calculated for swatches washed in Detergent 7.

| | Column | | | | |
|---|---|---|---|---|---|
| | 7a | 7b | 7c | 7d | 7e |
| Addition of enzyme | − | − | + | − | + |
| cocktail | | | | | |
| Temperature | 40° C. | 20° C. | 20° C. | 20° C. | 20° C. |
| Wash process | Normal | Normal | Normal | 2-stage | 2-stage |
| Swatch No: | | | | | |
| CS-61 | 35 | 18 | 21 | 20 | 24 |
| EMPA 120 | 2 | 2 | 2 | 1 | 3 |
| wfk 10D | 16 | 15 | 14 | 17 | 17 |
| wfk 20D | 14 | 12 | 15 | 15 | 19 |
| wfk 20MU | 16 | 14 | 16 | 16 | 17 |
| EMPA 101 | 7 | 5 | 4 | 4 | 4 |
| EMPA 106 | 9 | 7 | 7 | 4 | 9 |
| wfk 10TE | 11 | 10 | 10 | 12 | 12 |
| wfk 10PPM | 12 | 4 | 12 | 8 | 21 |
| C-S-01 | 4 | 2 | 4 | 3 | 4 |
| EMPA 117 | 10 | 6 | 13 | 8 | 14 |
| EMPA 164 | 5 | 4 | 7 | 6 | 11 |
| wfk 10N | 28 | 25 | 28 | 25 | 29 |
| EMPA 114 | 15 | 10 | 10 | 11 | 11 |
| wfk 10J | 8 | 6 | 7 | 9 | 9 |
| CS-60 | 22 | 19 | 22 | 20 | 24 |
| CS-28 | 17 | 11 | 24 | 12 | 27 |
| C-H097 | 36 | 28 | 37 | 32 | 36 |
| EMPA 112 | 15 | 9 | 13 | 11 | 17 |
| C-S-06 | 10 | 7 | 14 | 10 | 19 |
| wfk 10A | 1 | 0 | 0 | 2 | 2 |
| wfk 30A | −9 | −5 | −5 | −5 | −4 |
| TOTAL | 283 | 208 | 278 | 240 | 325 |
| Relative Wash | 1.00 | 0.73 | 0.98 | 0.85 | 1.15 |
| Performance (RWP) | | | | | |
| Process Related | — | 1.00 | 1.00 | 1.15 | 1.17 |
| Cleaning Index (PRCI) | | | | | |

Column 7a shows the result of a normal wash at 40° C. with Detergent 7.
Column 7b shows the result of a Normal wash at 20° C. with Detergent 7.
Column 7c shows the result of a Normal Wash at 20° C. with Detergent 7 + Enzymes.
Column 7d shows the result of a 2-stage wash at 20° C. with Detergent 7.
Column 7e shows the result of a 2-stage wash at 20° C. with Detergent 7 + Enzymes.

### CONCLUSION

The results show that the overall (Total) wash performance of the 2-stage wash process with enzymes at 20° C. (column e) is higher relative to a normal wash at 40° C. (column a). The 2-stage wash process provides an improved cleaning in comparison with benchmark irrespective of the absence or the presence of additional enzymes. This is apparent from the Process Related Cleaning Index (PRCI) which is 1.15 in the absence of enzymes and 1.17 in the presence of enzymes respectively.

### Example 8

### Wash with Detergent 8

Detergent 8 is a liquid formulation with a pH around 9.1 to 9.2 with enzymes. For each wash an amount of 0.570 g detergent composition as listed below were used.

TABLE 8A
Detergent 8 composition

| | content in detergent |
|---|---|
| | composition by weight |
| | (%) of active substance |
| | specified |
| surfactants | |
| linear alkylbenzenesulfonate, sodium salt | 11.0 |
| fatty acid methyl ester sulfonate, sodium salt | 4.1 |
| soap, sodium salt | 0.3 |
| alcohol ethoxylate | 16.7 |
| total surfactants | 32.1 |
| water | 63.6 |
| sodium toluenesulfonate | 1.0 |
| trisodium citrate dihydrate | 0.3 |
| disodium tetraborate pentahydrate (borax) | 1.5 |
| sodium sulfate (anhydrous) | 0.1 |
| sodium chloride | 0.1 |
| enzymes | |
| protease | 0.018 |
| amylase | 0.009 |

TABLE 8B
Amount of Surfactant and Enzymes used

| | | g per L | g per g |
|---|---|---|---|
| | | soak liquor | textile |
| total surfactants | | 4.6 | 0.0091 |
| | | mg active | mg active |
| added enzymes | | enzyme | enzyme |
| according to | | protein per L | protein per |
| invention | Product | soak liquor | g textile |
| protease | Savinase 16 L | 48.0 | 0.0960 |
| amylase | Stainzyme 12.0 L | 22.5 | 0.0450 |
| lipase | Lipex 100 L | 1.7 | 0.0025 |
| cellulase | Celluclean 5.0 T | 7.0 | 0.0140 |
| mannanase | Mannaway 4.0 L | 0.9 | 0.0018 |

TABLE 8C
ΔRem calculated for swatches washed in Detergent 8.

| | Column | | | | |
|---|---|---|---|---|---|
| | 8a | 8b | 8c | 8d | 8e |
| Addition of enzyme | − | − | + | − | + |
| cocktail | | | | | |
| Temperature | 40° C. | 20° C. | 20° C. | 20° C. | 20° C. |
| Wash process | Normal | Normal | Normal | 2-stage | 2-stage |
| Swatch No: | | | | | |
| CS-61 | 37 | 18 | 23 | 24 | 33 |
| EMPA 120 | 3 | 5 | 2 | 1 | 2 |
| wfk 10D | 17 | 15 | 13 | 17 | 18 |
| wfk 20D | 16 | 14 | 16 | 16 | 19 |
| wfk 20MU | 15 | 14 | 15 | 16 | 14 |
| EMPA 101 | 6 | 4 | 4 | 4 | 4 |
| EMPA 106 | 11 | 6 | 9 | 10 | 10 |
| wfk 10TE | 10 | 10 | 9 | 11 | 10 |
| wfk 10PPM | 14 | 7 | 10 | 11 | 18 |
| C-S-01 | 4 | 4 | 5 | 4 | 3 |
| EMPA 117 | 11 | 6 | 10 | 6 | 5 |
| EMPA 164 | 8 | 5 | 6 | 7 | 4 |
| wfk 10N | 26 | 23 | 24 | 21 | 23 |
| EMPA 114 | 15 | 10 | 10 | 10 | 8 |
| wfk 10J | 7 | 5 | 5 | 7 | 7 |
| CS-60 | 21 | 19 | 22 | 19 | 22 |
| CS-28 | 20 | 10 | 25 | 11 | 27 |
| C-H097 | 37 | 28 | 32 | 28 | 36 |
| EMPA 112 | 10 | 8 | 14 | 12 | 11 |
| C-S-06 | 9 | 6 | 12 | 10 | 13 |
| wfk 10A | 1 | 0 | 1 | 1 | 1 |
| wfk 30A | −7 | −5 | −5 | −5 | −5 |
| TOTAL | 290 | 213 | 264 | 240 | 283 |
| Relative Wash | 1.00 | 0.73 | 0.91 | 0.83 | 1.01 |
| Performance (RWP) | | | | | |
| Process Related | — | 1.00 | 1.00 | 1.13 | 1.07 |
| Cleaning Index (PRCI) | | | | | |

Column 8a shows the result of a normal wash at 40° C. with Detergent 8.
Column 8b shows the result of a Normal wash at 20° C. with Detergent 8.
Column 8c shows the result of a Normal Wash at 20° C. with Detergent 8 + Enzymes.
Column 8d shows the result of a 2-stage wash at 20° C. with Detergent 8.
Column 8e shows the result of a 2-stage wash at 20° C. with Detergent 8 + Enzymes.

### CONCLUSION

The results show that the overall (Total) wash performance of the 2-stage wash process with enzymes at 20° C. (column e) is higher relative to a normal wash at 40° C. (column a). The 2-stage wash process provides an improved cleaning in comparison with benchmark irrespective of the absence or the presence of additional enzymes. This is apparent from the Process Related Cleaning Index (PRCI) which is 1.13 in the absence of enzymes and 1.07 in the presence of enzymes respectively.

### Example 9

### Wash with Detergent 9

Detergent 9 is a liquid formulation with a pH around 10.6 to 10.8 without enzymes and a low level of surfactant. For each wash an amount of 0.580 g detergent composition as listed below were used.

TABLE 9A
Detergent 9 composition

| | content in detergent |
|---|---|
| | composition by weight |
| | (%) of active substance |
| | specified |
| surfactants | |
| linear alkylbenzenesulfonate, sodium salt | 1.5 |
| alkylethoxysulfate, sodium salt | 5.2 |
| soap, sodium salt | 0.5 |
| alcohol ethoxylate | 5.0 |
| total surfactants | 12.2 |
| water | 83.1 |
| sodium sulfate (anhydrous) | 0.1 |
| sodium carbonate (anhydrous) | 3.2 |
| sodium polyacrylate | 0.2 |
| 4,4′-bis[(4-anilino-6-morpholino-1,3,5- | 0.12 |
| triazine-2-yl)amino]stilbene-2,2′- | |
| disulfonic acid, sodium salt | |

TABLE 9B
Amount of Surfactant and Enzymes used

| | | g per L | g per g |
|---|---|---|---|
| | | soak liquor | textile |
| total surfactants | | 1.8 | 0.0035 |
| | | mg active | mg active |
| added enzymes | | enzyme | enzyme |
| according to | | protein per L | protein per |
| invention | Product | soak liquor | g textile |
| protease | Savinase 16 L | 48.0 | 0.0960 |
| amylase | Stainzyme 12.0 L | 22.5 | 0.0450 |
| lipase | Lipex 100 L | 1.7 | 0.0025 |
| cellulase | Celluclean 5.0 T | 7.0 | 0.0140 |
| mannanase | Mannaway 4.0 L | 0.9 | 0.0018 |

TABLE 9C
ΔRem calculated for swatches washed in Detergent 9.

| | Column | | | | |
|---|---|---|---|---|---|
| | 9a | 9b | 9c | 9d | 9e |
| Addition of enzyme | − | − | + | − | + |
| cocktail | | | | | |
| Temperature | 40° C. | 20° C. | 20° C. | 20° C. | 20° C. |
| Wash process | Normal | Normal | Normal | 2-stage | 2-stage |
| Swatch No: | | | | | |
| CS-61 | 35 | 20 | 22 | 18 | 30 |
| EMPA 120 | 2 | 1 | 3 | 2 | 2 |
| wfk 10D | 16 | 14 | 13 | 15 | 19 |
| wfk 20D | 14 | 12 | 14 | 12 | 18 |
| wfk 20MU | 14 | 14 | 11 | 16 | 16 |
| EMPA 101 | 6 | 4 | 3 | 4 | 5 |
| EMPA 106 | 9 | 5 | 8 | 9 | 13 |
| wfk 10TE | 9 | 9 | 9 | 11 | 10 |
| wfk 10PPM | 5 | 4 | 8 | 4 | 19 |
| C-S-01 | 2 | 9 | 3 | 4 | 5 |
| EMPA 117 | 5 | 5 | 7 | 5 | 12 |
| EMPA 164 | 5 | -2 | 5 | 5 | 5 |
| wfk 10N | 22 | 18 | 23 | 22 | 26 |
| EMPA 114 | 14 | 7 | 9 | 11 | 10 |
| wfk 10J | 3 | 7 | 5 | 4 | 5 |
| CS-60 | 20 | 13 | 20 | 18 | 23 |
| CS-28 | 10 | 18 | 26 | 8 | 27 |
| C-H097 | 27 | 23 | 37 | 27 | 37 |
| EMPA 112 | 7 | 9 | 9 | 7 | 14 |
| C-S-06 | 6 | 2 | 9 | 5 | 14 |
| wfk 10A | 0 | -9 | 1 | 1 | 2 |
| wfk 30A | −7 | −3 | −5 | −5 | −5 |
| TOTAL | 223 | 181 | 244 | 206 | 310 |
| Relative Wash | 1.00 | 0.81 | 1.09 | 0.92 | 1.39 |
| Performance (RWP) | | | | | |
| Process Related | — | 1.00 | 1.00 | 1.14 | 1.27 |
| Cleaning Index (PRCI) | | | | | |

Column 9a shows the result of a normal wash at 40° C. with Detergent 9.
Column 9b shows the result of a Normal wash at 20° C. with Detergent 9.
Column 9c shows the result of a Normal Wash at 20° C. with Detergent 9 + Enzymes.
Column 9d shows the result of a 2-stage wash at 20° C. with Detergent 9.
Column 9e shows the result of a 2-stage wash at 20° C. with Detergent 9 + Enzymes.

### CONCLUSION

The results show that the overall (Total) wash performance of the 2-stage wash process with enzymes at 20° C. (column e) is higher relative to a normal wash at 40° C. (column a). The 2-stage wash process provides an improved cleaning in comparison with benchmark irrespective of the absence or the presence of additional enzymes. This is apparent from the Process Related Cleaning Index (PRCI) which is 1.14 in the absence of enzymes and 1.27 in the presence of enzymes respectively.

### Example 10

### Wash with Detergent 10

Detergent 10 is a liquid formulation with a pH around 8.1 to 8.3 without enzymes and a low level of surfactant. For each wash an amount of 0.560 g detergent composition as listed below were used.

TABLE 10A
Detergent 10 composition

| | content in detergent |
|---|---|
| | composition by weight |
| | (%) of active substance |
| | specified |
| surfactants | |
| fatty acid methyl ester sulfonate, sodium salt | 5.1 |
| soap, sodium salt | 0.5 |
| fatty acid dialkanolamide | 6.1 |
| total surfactants | 11.7 |
| water | 86.9 |
| glycerol | 0.4 |
| sodium toluenesulfonate | 0.4 |
| trisodium citrate dihydrate | 0.1 |
| sodium sulfate (anhydrous) | 0.1 |
| sodium chloride | 0.1 |
| 4,4′-bis[(4-anilino-6-morpholino-1,3,5- | 0.01 |
| triazine-2-yl)amino]stilbene-2,2′- | |
| disulfonic acid, sodium salt | |
| enzymes | |
| protease | 0.018 |

TABLE 10B
Amount of Surfactant and Enzymes used

| | | g per L | g per g |
|---|---|---|---|
| | | soak liquor | textile |
| total surfactants | | 1.6 | 0.0033 |
| | | mg active | mg active |
| added enzymes | | enzyme | enzyme |
| according to | | protein per | protein per |
| invention | Product | L soak liquor | g textile |
| protease | Savinase 16 L | 48.0 | 0.0960 |
| amylase | Stainzyme 12.0 L | 22.5 | 0.0450 |
| lipase | Lipex 100 L | 1.7 | 0.0025 |
| cellulase | Celluclean 5.0 T | 7.0 | 0.0140 |
| mannanase | Mannaway 4.0 L | 0.9 | 0.0018 |

TABLE 10C
ΔRem calculated for swatches washed in Detergent 10.

| | Column | | | | |
|---|---|---|---|---|---|
| | 10a | 10b | 10c | 10d | 10e |
| Addition cf enzyme | − | − | + | − | + |
| cocktail | | | | | |
| Temperature | 40° C. | 20° C. | 20° C. | 20° C. | 20° C. |
| Wash process | Normal | Normal | Normal | 2-stage | 2-stage |
| Swatch No: | | | | | |
| CS-61 | 37 | 20 | 21 | 23 | 25 |
| EMPA 120 | 1 | 1 | 4 | 2 | 2 |
| wfk 10D | 12 | 11 | 12 | 12 | 18 |
| wfk 20D | 10 | 10 | 14 | 12 | 15 |
| wfk 20MU | 14 | 12 | 13 | 13 | 14 |
| EMPA 101 | 6 | 2 | 5 | 4 | 4 |
| EMPA 106 | 9 | 5 | 6 | 7 | 11 |
| wfk 10TE | 9 | 8 | 9 | 9 | 10 |
| wfk 10PPM | 5 | 2 | 9 | 5 | 14 |
| C-S-01 | 1 | 0 | 4 | 1 | 2 |
| EMPA 117 | 4 | 4 | 10 | 3 | 11 |
| EMPA 164 | 4 | 4 | 6 | 4 | 4 |
| wfk 10N | 19 | 18 | 23 | 17 | 22 |
| EMPA 114 | 14 | 9 | 9 | 9 | 6 |
| wfk 10J | 6 | 4 | 4 | 7 | 2 |
| CS-60 | 19 | 17 | 21 | 18 | 22 |
| CS-28 | 9 | 8 | 26 | 8 | 26 |
| C-H097 | 26 | 25 | 37 | 27 | 35 |
| EMPA 112 | 7 | 8 | 13 | 8 | 14 |
| C-S-06 | 6 | 4 | 10 | 5 | 11 |
| wfk 10A | 0 | 0 | 0 | 1 | 2 |
| wfk 30A | −8 | −6 | − 5 | −5 | −5 |
| TOTAL | 209 | 167 | 250 | 191 | 267 |
| Relative Wash | 1.00 | 0.80 | 1.20 | 0.91 | 1.28 |
| Performance (RWP) | | | | | |
| Process Related | — | 1.00 | 1.00 | 1.14 | 1.07 |
| Cleaning Index (PRCI) | | | | | |

Column 10a shows the result of a normal wash at 40° C. with Detergent 10.
Column 10b shows the result of a Normal wash at 20° C. with Detergent 10.
Column 10c shows the result of a Normal Wash at 20° C. with Detergent 10 + Enzymes.
Column 10d shows the result of a 2-stage wash at 20° C. with Detergent 10.
Column 10e shows the result of a 2-stage wash at 20° C. with Detergent 10 + enzymes.

### CONCLUSION

The results show that the overall (Total) wash performance of the 2-stage wash process with enzymes at 20° C. (column e) is higher relative to a normal wash at 40° C. (column a). The 2-stage wash process provides an improved cleaning in comparison with benchmark irrespective of the absence or the presence of additional enzymes. This is apparent from the Process Related Cleaning Index (PRCI) which is 1.14 in the absence of enzymes and 1.07 in the presence of enzymes respectively.

### Example 11

### Wash with Detergent 11

Detergent 11 is a liquid formulation with a pH around 11.2 to 11.4 without enzymes and a low level of surfactant. For each wash an amount of 0.580 g detergent composition as listed below were used.

TABLE 11A
Detergent 11 composition

| | content in detergent |
|---|---|
| | composition by weight |
| | (%) of active substance |
| | specified |
| surfactants | |
| linear alkylbenzenesulfonate, | 2.0 |
| sodium salt | |
| alkylethoxysulfate, | 3.1 |
| sodium salt | |
| soap, sodium salt | 0.3 |
| alcohol ethoxylate | 0.7 |
| total surfactants | 6.1 |
| water | 89.1 |
| sodium carbonate (anhydrous) | 4.1 |
| sodium polyacrylate | 0.7 |
| 4,4′-bis[(4-anilino-6- | 0.10 |
| morpholino-1,3,5-triazine-2- | |
| yl)amino]stilbene-2,2′- | |
| disulfonic acid, sodium salt | |

TABLE 11B
Amount of Surfactant and Enzymes used

| | | g per L | g per g |
|---|---|---|---|
| | | soak liquor | textile |
| total surfactants | | 0.88 | 0.0018 |
| | | mg active | mg active |
| added enzymes | | enzyme | enzyme |
| according to | | protein per L | protein per |
| invention | Product | soak liquor | g textile |
| protease | Savinase 16 L | 48.0 | 0.0960 |
| amylase | Stainzyme 12.0 L | 22.5 | 0.0450 |
| lipase | Lipex 100 L | 1.7 | 0.0025 |
| cellulase | Celluclean 5.0 T | 7.0 | 0.0140 |
| mannanase | Mannaway 4.0 L | 0.9 | 0.0018 |

TABLE 11C
ΔRem calculated for swatches washed in Detergent 11.

| | Column | | | | |
|---|---|---|---|---|---|
| | 11a | 11b | 11c | 11d | 11e |
| Addition of enzyme | − | − | + | − | + |
| cocktail | | | | | |
| Temperature | 40° C. | 20° C. | 20° C. | 20° C. | 20° C. |
| Wash process | Normal | Normal | Normal | 2-stage | 2-stage |
| Swatch No : | | | | | |
| CS-61 | 34 | 22 | 20 | 19 | 30 |
| EMPA 120 | 0 | 3 | 2 | 2 | 0 |
| wfk 10D | 12 | 11 | 11 | 11 | 13 |
| wfk 20D | 6 | 7 | 14 | 7 | 16 |
| wfk 20MU | 13 | 12 | 13 | 13 | 14 |
| EMPA 101 | 4 | 4 | 5 | 5 | 4 |
| EMPA 106 | 9 | 9 | 7 | 12 | 6 |
| wfk 10TE | 7 | 8 | 9 | 8 | 10 |
| wfk 10PPM | 3 | 2 | 11 | 2 | 14 |
| C-S-01 | 4 | 0 | 5 | 4 | 3 |
| EMPA 117 | 4 | 4 | 13 | 5 | 8 |
| EMPA 164 | 4 | 3 | 6 | 3 | 8 |
| wfk 10N | 21 | 21 | 28 | 18 | 24 |
| EMPA 114 | 10 | 8 | 9 | 8 | 9 |
| wfk 10J | −2 | −1 | 2 | 0 | 5 |
| CS-60 | 20 | 17 | 21 | 18 | 23 |
| CS-28 | 10 | 8 | 26 | 9 | 26 |
| C-H097 | 28 | 22 | 37 | 27 | 36 |
| EMPA 112 | 10 | 6 | 14 | 5 | 12 |
| C-S-06 | 5 | 4 | 9 | 6 | 13 |
| wfk 10A | 0 | 1 | −1 | 1 | 2 |
| wfk 30A | −10 | −6 | −4 | −5 | −4 |
| TOTAL | 189 | 164 | 255 | 179 | 272 |
| Relative Wash | 1.00 | 0.87 | 1.35 | 0.95 | 1.44 |
| Performance (RWP) | | | | | |
| Process Related | — | 1.00 | 1.00 | 1.09 | 1.07 |
| Cleaning Index (PRCI) | | | | | |

Column 11a shows the result of a normal wash at 40° C. with Detergent 11.
Column 11b shows the result of a Normal wash at 20° C. with Detergent 11.
Column 11c shows the result of a Normal Wash at 20° C. with Detergent 11 + Enzymes.
Column 11d shows the result of a 2-stage wash at 20° C. with Detergent 11.
Column 11e shows the result of a 2-stage wash at 20° C. with Detergent 11 + Enzymes.

### CONCLUSION

The results show that the overall (Total) wash performance of the 2-stage wash process with enzymes at 20° C. (column e) is higher relative to a normal wash at 40° C. (column a). The 2-stage wash process provides an improved cleaning in comparison with benchmark irrespective of the absence or the presence of additional enzymes. This is apparent from the Process Related Cleaning Index (PRCI) which is 1.09 in the absence of enzymes and 1.07 in the presence of enzymes respectively.

### Example 12

### TOM Wash and Large Scale Front Load Wash with Detergent 12

Detergent 12 is a powder formulation with a pH around 10.7 without enzymes. For each small scale wash an amount of 0.580 g and for each large scale wash an amount of 65 g detergent composition as listed below were used.

TABLE 12Aa
Detergent 12 composition for small scale wash

| | content in |
|---|---|
| | detergent |
| | composition |
| | by weight |
| | (%) of active |
| | substance |
| | specified |
| surfactants | |
| linear alkylbenzenesulfonate, sodium salt | 11.0 |
| alcoholethoxylate | 5.9 |
| soap, sodium salt | 4.1 |
| total surfactants | 21.0 |
| zeolite 4A | 36.8 |
| sodium carbonate (anhydrous) | 13.4 |
| sodium silicate | 3.8 |
| sodium sulfate (anhydrous) | 18.4 |
| diethylenetriaminepentakis(methylene)pentaphosphonic | 3.5 |
| acid (DTMPA), sodium salt | |
| copoly(acrylic acid/maleic acid), sodium acrylate | 5.9 |
| silicone oil | 0.6 |
| 4,4′-bis[(4-anilino-6-morpholino-1,3,5-triazine-2- | 0.04 |
| yl)amino]stilbene-2,2′-disulfonic acid, sodium salt | |

TABLE 12Ab
Detergent 12 composition for large scale wash

| | content in |
|---|---|
| | detergent |
| | composition |
| | by weight |
| | (%) of active |
| | substance |
| | specified |
| surfactants | |
| linear alkylbenzenesulfonate, sodium salt | 11.0 |
| alcoholethoxylate | 5.9 |
| soap, sodium salt | 4.1 |
| total surfactants | 21.0 |
| zeolite 4A | 36.8 |
| sodium carbonate (anhydrous) | 13.4 |
| sodium silicate | 3.8 |
| sodium sulfate (anhydrous) | 18.4 |
| diethylenetriaminepentakis(methylene)pentaphosphonic | 3.5 |
| acid (DTMPA), sodium salt | |
| carboxymethylcellulose | 1.5 |
| copoly(acrylic acid/maleic acid), sodium salt | 5.9 |
| silicone oil | 0.6 |
| 4,4′-bis[(4-anilino-6-morpholino-1,3,5-triazine-2- | 0.04 |
| yl)amino]stilbene-2,2′-disulfonic acid, sodium salt | |
| enzymes | |
| protease | 0.008 |

TABLE 12Ba
Amount of Surfactant and Enzymes used for small scale

| | | g per L | g per g |
|---|---|---|---|
| | | soak liquor | textile |
| total surfactants | | 6.1 | 0.012 |
| | | mg active | mg active |
| added enzymes | | enzyme | enzyme |
| according to | | protein per L | protein per |
| invention | Product | soak liquor | g textile |
| protease | Savinase 16 L | 48.0 | 0.0960 |
| amylase | Stainzyme 12.0 L | 22.5 | 0.0450 |
| lipase | Lipex 100 L | 1.7 | 0.0025 |
| cellulase | Celluclean 5.0 T | 7.0 | 0.0140 |
| mannanase | Mannaway 4.0 L | 0.9 | 0.0018 |

TABLE 12Bb
Amount of Surfactant and Enzymes used for large scale

| | | g per L | g per g |
|---|---|---|---|
| | | soak liquor | textile |
| total surfactants | | 3.4 | 0.0053 |
| | | mg active | mg active |
| added enzymes | | enzyme | enzyme |
| according to | | protein per L | protein per |
| invention | Product | soak liquor | g textile |
| protease | Savinase 16 L | 62.4 | 0.0960 |
| amylase | Stainzyme 12.0 L | 29.3 | 0.0450 |
| lipase | Lipex 100 L | 15.0 | 0.0230 |
| cellulase | Celluclean 5.0 T | 9.1 | 0.0140 |

### Description of Large Scale Front Load Wash

Ballast: 6 cotton T-shirts. 8 shirts and 1 t-towel of a total weight of 2.6 kg was used as ballast fabric. Ballast was pre-washed with 5 g/L Liquid “Neutral” a commercial detergent without enzymes using the wash program: 40° C. “koge/kulørt” in tap water in an EU front load machine. 100 mL 5% acetic acid was added to the rinse. The second rinse was performed in tap water using the program “STIVELSE” after which the ballast was tumble dried. After test wash the ballast was inactivated in tap water at 95° C. using an EU front load machine.

Stained swatches: During wash two of each soiled swatches were attached to two t-towel. After wash all swatches were removed from the T-towel and placed on filter paper and dried over night in darkness. The swatches were evaluated and delta remission values calculated as described above.

Enzymes: The following enzymes: Amylase, Celluclean, Lipex, Savinase were used at the concentrations given in table II. Celluclean was added with the detergent and stirred for 10 minutes. The liquid enzymes were added to the soak or wash volume just before use.

Detergent: Detergent 12 was used at a dosage of 5 g/L wash solution corresponding to 65 g per wash.

Water: Water hardness to 15° dH was adjusted after heating of water to the desired temperature by addition of 2.5 ml/L of a Ca/Mg 4:1 6000° dH/L stock solution and 7.5 ml/L of a 0.535 M Sodium hydrogencarbonate stock solution.

Front load washing device: The Miele Profitronic PW 6 1601 is not designed for wash with low water volumes such as the concentrated soak wash. Suitable wash programs were designed using the Profitronic M 1.1.214 software. Programs for a normal wash process, concentrated soak wash, as well as programs for Rinse 1 and Rinse 2 are outlined in the table below. The two rinse programs using cold tap water (22° dH) were applied in all wash processes.

Miele Profitronic PW6101 Wash Programs

| Normal wash program | 2-stage wash program |
|---|---|
| Miele Profitronic | Miele Profitronic |
| PW6101 Program 1 | PW6101 Program 2. |
| Block data Area 2 | Block data Area 2 |
| Block 1, Main wash: | Block 1, Main wash: |
| 1) Block activation: | 1) Block activation: |
| Permanent | Permanent |
| 2) Programme stop | 2) Programme stop |
| 1: No | 1: No |
| 3) Programme stop | 3) Programme stop |
| signal 1: No | signal 1: No |
| 4) Heating: Yes | 4) Heating: Yes |
| 5) Freely selectable | 5) Freely selectable |
| temperature/parameter: | temperature/parameter: |
| Yes | Yes |
| 6) Temperature: Cold | 6) Temperature: Cold |
| 7) Hysteresis: Normal | 7) Hysteresis: Normal |
| 8) Warm up: No | 8) Warm up: No |
| 9) Level 1: 0 mm wc | 9) Level 1: 0 mm wc |
| 10) Intake path 1: Automatic | 10) Intake path 1: Automatic |
| 11) Dispensing type: No | 11) Dispensing type: No |
| 14) Movement from level, | 14) Movement from level, |
| movement level: Userdefined, | movement level: Userdefined, |
| Rhythm: Gentle +, Time: 5:00 | Rhythm: Normal, Time: 4:00 |
| min:s, Drum speed: Scooping, | min:s, Drum speed: Normal, |
| Start of drum rotation: 0 mm | Start of drum rotation: 0 mm |
| wc | wc |
| 15) Level stop 1: No | 15) Level stop 1: No |
| 16) Wash time 1: Scooping | 16) Wash time 1: 0 U/min |
| 04:00 min:s Rhythm: Gentle + | 05:00 min:s Rhythm: No |
| 17) Thermostop: No | 17) Thermostop: No |
| 18) Level 2: 0 mm wc | 18) Level 2: 0 mm wc |
| 19) Intake path 2: Automatic | 19) Intake path 2: Automatic |
| 22) Level stop 2: No | 22) Level stop 2: No |
| 23) Wash time 2: Scooping | 23) Wash time 2: Scooping |
| 07:00 min:s Rhythm: Gentle + | 07:00 min:s Rhythm: Gentle + |
| 24) Cooling down: No | 24) Cooling down: No |
| 25) Wash time 3: Scooping | 25) Wash time 3: Scooping |
| 04:00 min:s Rhythm: Gentle + | 03:00 min:s Rhythm: Gentle + |
| 26) Programme stop 2: No | 26) Programme stop 2: No |
| 27) Programme stop signal 2: | 27) Programme stop signal 2: |
| No | No |
| 28) Drain path 1: Drainage | 28) Drain path 1: Drainage |
| 29) Drain level: 0 mm wc | 29) Drain level: 0 mm wc |
| 30) Wash time 4: 0 U/min | 30) Wash time 4: 0 U/min |
| 00:00 min:s Rhythm: No | 00:00 min:s Rhythm: No |
| 31) Drain path 2: Drainage | 31) Drain path 2: Drainage |
| 32) Freely selectable spin | 32) Freely selectable spin |
| speed: No | speed: No |
| 33) Spin: No | 33) Spin: No |
| 34) Block repetition: | 34) Block repetition: |
| Blocks:: No Programmes:: | Blocks:: No Programmes:: |
| No | No |
| 35) Block end signal: No | 35) Block end signal: No |
| | Washing |

| Rinse 1 - Block | Rinse 2 - Block |
|---|---|
| data Area 3 Block 1 | data Area 3 Block 2 |
| 1) Block activation: Permanent | 1) Block activation: Permanent |
| 2) Programme stop 1: No | 2) Programme stop 1: No |
| 3) Programme stop signal 1: No | 3) Programme stop signal 1: No |
| 4) Heating: No | 4) Heating: No |
| 5) Freely selectable | 5) Freely selectable |
| temperature/parameter: No | temperature/parameter: No |
| 6) Temperature: Cold | 6) Temperature: Cold |
| 7) Hysteresis: Normal | 7) Hysteresis: Normal |
| 9) Level 1: 50 mm wc | 9) Level 1:50 mm wc |
| 10) Intake path 1: Automatic | 10) Intake path 1: Automatic |
| 11) Dispensing type: No | 11) Dispensing type: No |
| 14) Movement from level, | 14) Movement from level, |
| movement level: Userdefined, | movement level: Userdefined, |
| Rhythm: Gentle, Time: 4:00 | Rhythm: Gentle, Time: 4:00 |
| min:s, Drum speed: Scooping, | min:s, Drum speed: Scooping, |
| Start of drum rotation: 50 mm | Start of drum rotation: 50 mm |
| wc | wc |
| 15) Level stop 1: Yes | 15) Level stop 1: Yes |
| 16) Wash time 1: 0 U/min 00:30 | 16) Wash time 1: 0 U/min 00:00 |
| min:s Rhythm: No | min:s Rhythm: No |
| 17) Thermostop: No | 17) Thermostop: No |
| 18) Level 2: 50 mm wc | 18) Level 2: 60 mm wc |
| 19) Intake path 2: Automatic | 19) Intake path 2: Automatic |
| 22) Level stop 2: No | 22) Level stop 2: No |
| 23) Wash time 2: 0 U/min 00:00 | 23) Wash time 2: 0 U/min 00:00 |
| min:s Rhythm: No | min:s Rhythm: No |
| 24) Cooling down: No | 24) Cooling down: No |
| 25) Wash time 3: 0 U/min 00:00 | 25) Wash time 3: 0 U/min 00:00 |
| min:s Rhythm: No | min:s Rhythm: No |
| 26) Programme stop 2: No | 26) Programme stop 2: Spin stop |
| 27) Programme stop signal 2: No | 27) Programme stop signal 2: Yes |
| 28) Drain path 1: Drainage | 28) Drain path 1: Drainage |
| 29) Drain level: 0 mm wc | 29) Drain level: 0 mm wc |
| 30) Wash time 4: 0 U/min 00:00 | 30) Wash time 4: 0 U/min 00:00 |
| min:s Rhythm: No | min:s Rhythm: No |
| 31) Drain path 2: Drainage | 31) Drain path 2: Drainage |
| 32) Freely selectable spin speed: | 32) Freely selectable spin speed: |
| No | Yes |
| 33) Spin: No | 33) Spin: Userdefined |
| 34) Block repetition: Blocks:: | Spin phase 1: 500 U/min 02:00 |
| No Programmes:: No | min:s Rhythm: No |
| 35) Block end signal: No | Spin phase 2: Normal 00:30 |
| Washing | min:s Rhythm: Gentle |
| | Spin phase 3: 1200 U/min 06:00 |
| | MIN_0:s Rhythm: No |
| | Spin phase 4: Normal 00:30 |
| | min:s Rhythm: Gentle |
| | Spin phase 5: No |
| | Spin phase 6: No |
| | 34) Block repetition: Blocks:: |
| | No Programmes:: No |
| | 35) Block end signal: Yes |
| | Washing |

Normal wash process (large scale): Place the dry ballast fabric and the two t-towels with soiled test swatches into Miele Profitronic PW6101. The temperature of the water is adjusted to 20° C. before use. Water hardness solutions were added to a beaker containing 4000 ml 20° C. de-ionized water to which detergent 12 was added and agitation applied for 10 minutes. If enzymes were needed Celluclean was added with the detergent and the other enzymes were added to the beaker just before pouring the wash solution into Miele Profitronic PW6101. Make 2×4500 ml with 20° C. de-ionized water with a water hardness of 15° dH. If a 40° C. wash is set up then the temperature of the water should be approximately 55° C. Add all 3 beakers of wash solution into the detergent dispenser and start Program 1.

2-stage wash process (large scale): The temperature of the water is adjusted to 20° C. before use. Water hardness solutions were added to a beaker containing 4000 ml 20° C. de-ionized water to which detergent 12 was added and agitation applied for 10 minutes. If enzymes were needed Celluclean was added with the detergent and the other enzymes were added to the beaker just before pouring the wash solution into Miele Profitronic PW6101.

Soak: Split the dry ballast fabric into three parts. Place one part in a 100 L clear plastic bag and place the first t-towel with soiled test swatches on top and pour over with 2 L soak solution. Add the second part of ballast fabric on top and place the second t-towel with soiled test swatches thereon and pour over with 1 L soak solution. Add the third part of ballast fabric and wet with the last 1 L soak solution. Close the bag securely with an electrician plastic strip leaving some air in the bag for the load to be able to mix during soak. Place the bag in Miele Profitronic PW6101 and start program 2. After 9 minutes the program is stopped.

Wash: The plastic bag is cut open. The plastic bag with the load, but not the top that are cut off is left in Miele Profitronic PW6101. Add 1×4000 ml and 1×5000 ml 20° C. de-ionized water with a water hardness of 15° dH. Continue program 2.

TABLE 12C
ΔRem calculated for swatches washed in Detergent 12.

| | Column | | | | |
|---|---|---|---|---|---|
| | 12a | 12b | 12c | 12d | 12e |
| Addition of enzyme | − | − | + | − | + |
| cocktail | | | | | |
| Temperature | 40° C. | 20° C. | 20° C. | 20° C. | 20° C. |
| Wash process | Normal | Normal | Normal | 2-stage | 2-stage |
| Swatch No: | | | | | |
| CS-61 | 44 | 34 | 41 | 34 | 38 |
| EMPA 120 | 6 | 9 | 8 | 24 | 23 |
| wfk 10D | 20 | 19 | 17 | 20 | 18 |
| wfk 20D | 18 | 18 | 20 | 24 | 19 |
| wfk 20MU | 19 | 17 | 17 | 17 | 18 |
| EMPA 101 | 9 | 5 | 6 | 9 | 9 |
| EMPA 106 | 14 | 10 | 15 | 12 | 12 |
| wfk 10TE | 15 | 13 | 14 | 13 | 15 |
| wfk 10PPM | 12 | 9 | 25 | 10 | 30 |
| C-S-01 | 17 | 16 | 19 | 26 | 25 |
| EMPA 117 | 9 | 6 | 34 | 5 | 34 |
| EMPA 164 | 7 | 8 | 16 | 9 | 20 |
| wfk 10N | 22 | 26 | 33 | 26 | 36 |
| EMPA 114 | 0 | 0 | 1 | 5 | 4 |
| wfk 10J | −8 | −9 | −8 | −4 | −5 |
| CS-60 | 22 | 19 | 23 | 19 | 22 |
| CS-28 | 10 | 9 | 26 | 8 | 26 |
| C-H097 | 33 | 35 | 50 | 29 | 46 |
| EMPA 112 | 8 | 11 | 25 | 8 | 25 |
| C-S-06 | 10 | 8 | 17 | 8 | 23 |
| wfk 10A | −1 | −1 | −1 | −1 | −1 |
| wfk 30A | −1 | 0 | 0 | −1 | 0 |
| TOTAL | 283 | 261 | 394 | 299 | 439 |
| Relative Wash | 1.00 | 0.92 | 1.39 | 1.06 | 1.55 |
| Performance (RWP) | | | | | |
| Process Related | — | 1.00 | 1.00 | 1.15 | 1.11 |
| Cleaning Index (PRCI) | | | | | |
| | Column | | | | |
| | 12f | 12g | 12h | 12i | 12j |
| Addition of enzyme | − | − | + | − | + |
| cocktail | | | | | |
| Temperature | 40° C. | 20° C. | 20° C. | 20° C. | 20° C. |
| Wash process | Normal | Normal | Normal | 2-stage | 2-stage |
| Swatch No: | | | | | |
| CS-61 | — | — | — | — | — |
| EMPA 120 | 9 | 8 | 9 | 28 | 28 |
| wfk 10D | 9 | 6 | 8 | 10 | 13 |
| wfk 20D | 21 | 14 | 17 | 19 | 20 |
| wfk 20MU | 11 | 10 | 11 | 14 | 16 |
| EMPA 101 | 6 | 5 | 5 | 11 | 12 |
| EMPA 106 | 6 | 4 | 6 | 11 | 10 |
| wfk 10TE | 10 | 10 | 11 | 12 | 14 |
| wfk 10PPM | 26 | 16 | 26 | 28 | 31 |
| C-S-01 | — | — | — | — | — |
| EMPA 117 | 28 | 15 | 28 | 27 | 33 |
| EMPA 164 | 9 | 6 | 14 | 15 | 25 |
| wfk 10N | 31 | 25 | 33 | 32 | 39 |
| EMPA 114 | 10 | 10 | 9 | 13 | 14 |
| wfk 10J | −4 | −6 | −6 | −3 | −3 |
| CS-60 | — | — | — | — | — |
| CS-28 | 15 | 12 | 31 | 11 | 31 |
| C-H097 | 23 | 21 | 33 | 30 | 42 |
| EMPA 112 | 14 | 9 | 21 | 19 | 27 |
| C-S-06 | — | — | — | — | — |
| wfk 10A | −2 | −1 | −1 | −2 | 0 |
| wfk 30A | −1 | 0 | −2 | −2 | 0 |
| TOTAL | 223 | 162 | 252 | 272 | 351 |
| Relative Wash | 1.00 | 0.73 | 1.13 | 1.22 | 1.57 |
| Performance (RWP) | | | | | |
| Process Related | — | 1.00 | 1.00 | 1.68 | 1.39 |
| Cleaning Index (PRCI) | | | | | |

Column 12a shows the result of a normal wash at 40° C. with Detergent 12.
Column 12b shows the result of a Normal wash at 20° C. with Detergent 12.
Column 12c shows the result of a Normal Wash at 20° C. with Detergent 12 + Enzymes.
Column 12d shows the result of a 2-stage wash at 20° C. with Detergent 12.
Column 12e shows the result of a 2-stage wash at 20° C. with Detergent 12 + Enzymes.
Column 12f shows the result of a normal wash at 40° C. with Detergent 12.
Column 12g shows the result of a Normal wash at 20° C. with Detergent 12.
Column 12h shows the result of a Normal Wash at 20° C. with Detergent 12 + Enzymes.
Column 12i shows the result of a 2-stage wash at 20° C. with Detergent 12.
Column 12j shows the result of a 2-stage wash at 20° C. with Detergent 12 + Enzymes

### CONCLUSIONS

The results for small scale TOM wash (column a to e) show that the overall (Total) wash performance of the 2-stage wash process with enzymes at 20° C. (column e) is higher relative to a normal wash at 40° C. (column a). The 2-stage wash process provides an improved cleaning in comparison with benchmark irrespective of the absence or the presence of additional enzymes. This is apparent from the Process Related Cleaning Index (PRCI) which is 1.15 in the absence of enzymes and 1.11 in the presence of enzymes respectively.

The results for Large scale Front load wash (column f to j) show that the overall (Total) wash performance of the 2-stage wash process with enzymes at 20° C. (column j) is higher relative to a normal wash at 40° C. (column f). The 2-stage wash process provides an improved cleaning in comparison with benchmark irrespective of the absence or the presence of additional enzymes. This is apparent from the Process Related Cleaning Index (PRCI) which is 1.68 in the absence of enzymes and 1.39 in the presence of enzymes respectively.

Comparison of wash data obtained in TOM is representative for large scale wash data.

### Example 13

### Large Scale Top Load Wash with Detergent 13

Detergent 13A and Detergent 13B are powder formulations with a pH around 9.8. These detergents are identical except for the presence of protease in detergent 13A. The enzymes have been inactivated by treatment in a microwave oven. For each wash an amount of 50 g detergent composition as listed below were used.

TABLE 13A
Detergent 13A and 13B compositions

| | content in detergent |
|---|---|
| | composition by weight |
| | (%) of active substance |
| | specified |
| surfactants | |
| linear alkylbenzenesulfonate, | 14.3 |
| sodium salt | |
| soap, sodium salt | 1.6 |
| Alcohol ethoxylate | 0.6 |
| total surfactants | 16.5 |
| zeolite 4A | 19.5 |
| sodium silicate | 17.4 |
| sodium carbonate (anhydrous) | 8.6 |
| sodium sulfate (anhydrous) | 32.0 |
| sodium chloride | 0.2 |
| copoly(acrylic acid/maleic acid), | 1.1 |
| sodium salt | |
| silicone oil | 0.1 |
| 4,4′-bis[(4-anilino-6-morpholino- | 0.05 |
| 1,3,5-triazine-2-yl)amino]stilbene- | |
| 2,2′-disulfonic acid, sodium salt | |
| 2,2′-[1,1′-biphenyl-4,4′-diylbis(ethene-2,1- | 0.04 |
| diyl)]di(benzenesulfonic acid), sodium salt | |
| enzymes | |
| protease | 0.018 |

TABLE 13B
Amount of Surfactant and Enzymes used

| | | g per L | g per g |
|---|---|---|---|
| | | soak liquor | textile |
| total surfactants | | | |
| | | mg active | mg active |
| added enzymes | | enzyme | enzyme |
| according to | | protein per L | protein per |
| invention | Product | soak liquor | g textile |
| protease | Savinase 16 L | 48.0 | 0.0960 |
| amylase | Stainzyme 12.0 L | 22.5 | 0.0450 |
| lipase | Lipex 100 L | 4.9 | 0.0076 |
| cellulase | Celluclean 5.0 T | 7.0 | 0.0140 |
| mannanase | Mannaway 4.0 L | 0.9 | 0.0018 |

Description of conditions for Large scale Top load washes

| | |
|---|---|
| Water hardness | 14^{o}dH (Ca:Mg:HCO₃ = 2:1:4.5) |
| Enzyme dosage | 0.5 ppm for Savinase and Lipex |
| | 0.2 ppm for Stainzyme and Celluclean |
| Swatch | 2 swatches per stain attached to two tea towels |
| Ballast textile | 1.5 Kg (4 - shirts; 3 - pillow cases; 1 - T-shirt; |
| | 2 - tea towels and socks for balance) |
| Repetitions | 2 measurements per swatch |
| | 3 repetitions |

Top loader washing device: The Royalstar XPB60-801S top loading semi-Automatic Washing Machine has two wash drums. One is in bigger size for wash process, and the other is in smaller size for spinning. Three control knobs can be found on front panel. Two of the knobs are designed to control wash time and spin time respectively. The middle one on is set as a switch between Heavy duty, Normal wash and Drain options. Thus, the operation of this type of washing machine is quite simple. Water levels (0 to 65 Litres), Wash time (0 to 15 minutes), Soaking time and Spin time can be adjusted manually in accordance with different wash conditions. The engine of agitator inside can even be started without water input.

The wash process: 24 grams of detergent 13 for the soak solution and 26 grams for the wash solution were placed in separate beakers. The enzymes contained in the detergent were deactivated by heating the powder in a microwave oven and cooled to room temperature prior to use. 3 L water was added to each beaker. Ballast and swatches were placed in a big plastic bag, and the 3-Liter soak solution was poured into the bag which was sealed and packed tightly. The plastic bag was placed in the wash drum without water and 5-minutes agitation was applied. After the 3-minute holding period the bag was opened and water was added to the wash drum to a total of 38 Liters. Add the wash solution to wash drum and turn on the agitation for 10-minutes washing. This was followed by two rinses (5 minutes, 38 Liters)) and a final spinning (5 minutes). The test swatches were removed from the tea towel and place on filter paper for drying in darkness at room temperature over night. The swatches were evaluated as described above.

TABLE 13C
ΔRem calculated for swatches washed in Detergent 13A or 13B.

| | Column | | | | | | | |
|---|---|---|---|---|---|---|---|---|
| | 13a | 13b | 13c | 13d | 13e | 13f | 13g | 13h |
| Detergent No: | 13A | 13A | 13B | 13B | 13B | 13B | 13B | 13B |
| Amount (g) detergent | 50 g | 50 g | 50 g | 50 g | 24 g/26 g | 24 g/26 g | 24 g/0 g | 24 g/0 g |
| added in soak/wash | | | | | | | | |
| Addition of enzyme | − | − | − | + | − | + | − | + |
| Temperature | 40° C. | 20° C. | 20° C. | 20° C. | 20° C. | 20° C. | 20° C. | 20° C. |
| Wash process | Normal | Normal | Normal | Normal | 2-stage | 2-stage | 2-stage | 2-stage |
| Swatch No | | | | | | | | |
| EMPA120 | 5 | 7 | 8 | 16 | 32 | 30 | 27 | 26 |
| WFK10D | 20 | 17 | 18 | 20 | 18 | 22 | 17 | 19 |
| WFK20D | 22 | 19 | 21 | 12 | 23 | 27 | 20 | 22 |
| WFK30D | 37 | 36 | 37 | 12 | 37 | 40 | 32 | 36 |
| WFK20MU | 14 | 11 | 13 | 11 | 14 | 16 | 12 | 11 |
| EMPA101 | 12 | 9 | 9 | 19 | 14 | 15 | 12 | 14 |
| EMPA106 | 16 | 13 | 14 | 23 | 17 | 20 | 17 | 16 |
| WFK10TE | 13 | 13 | 11 | 20 | 13 | 14 | 12 | 13 |
| C-05 | 23 | 19 | 9 | 58 | 10 | 36 | 9 | 32 |
| EMPA117 | 39 | 25 | 11 | 34 | 14 | 42 | 11 | 37 |
| EMPA164 | 10 | 7 | 4 | 11 | 5 | 16 | 4 | 15 |
| Grass | 42 | 40 | 29 | 45 | 33 | 42 | 34 | 42 |
| EMPA 114 | 8 | 8 | 9 | 34 | 7 | 8 | 7 | 10 |
| WFK10U | 19 | 14 | 14 | 21 | 14 | 16 | 14 | 15 |
| WFK10WB | 23 | 20 | 19 | 16 | 25 | 26 | 25 | 25 |
| CS-27 | 15 | 12 | 12 | 25 | 12 | 37 | 12 | 36 |
| CS-28 | 22 | 18 | 19 | 14 | 18 | 38 | 19 | 38 |
| CS-02 | 21 | 14 | 9 | 29 | 10 | 29 | 9 | 25 |
| EMPA112 | 29 | 22 | 18 | 32 | 23 | 39 | 18 | 34 |
| TOTAL | 391 | 323 | 284 | 452 | 340 | 514 | 311 | 465 |
| Relative Wash | 1.00 | 0.83 | 0.73 | 1.16 | 0.87 | 1.31 | 0.80 | 1.19 |
| Performance (RWP) | | | | | | | | |
| Process Related Cleaning | — | — | 1.00 | 1.00 | 1.20 | 1.14 | 1.10 | 1.03 |
| Index (PRCI) | | | | | | | | |

Column 13a shows the result of a normal wash at 40° C. with 50 g Detergent 13A.
Column 13b shows the result of a Normal wash at 20° C. with 50 g Detergent 13A.
Column 13c shows the result of a Normal Wash at 20° C. with 50 g Detergent 13B.
Column 13d shows the result of a Normal Wash at 20° C. with 50 g Detergent 13B + Enzymes.
Column 13e shows the result of a 2-stage wash at 20° C. with 24 g (in soak solution) + 26 g (in wash solution) Detergent 13B.
Column 13f shows the result of a 2-stage wash at 20° C. with 24 g (in soak solution) + 26 g (in wash solution) Detergent 13B + Enzymes.
Column 13g shows the result of a 2-stage wash at 20° C. with 24 g (in soak solution) + 0 g (in wash solution) Detergent 13B.
Column 13h shows the result of a 2-stage wash at 20° C. with 24 g (in soak solution) + 0 g (in wash solution) Detergent 13B + Enzymes.

### CONCLUSIONS

The results show that the wash performance is maintained at least the same level as in a normal wash when reducing the amount of detergent in the 2-stage wash process to approximately half the initial amount (compare column c with g and column d with h). This effect was obtained when the detergent was omitted from the wash solution which indicates that the wash process is effective with only detergent +/− enzymes present in the soak solution.

The invention described and claimed herein is not to be limited in scope by the specific aspects herein disclosed, since these aspects are intended as illustrations of several aspects of the invention. Any equivalent aspects are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control.

1-15. (canceled)

16. A method for cleaning an object comprising the steps:
(a) distributing to the object a first soak solution comprising at least one surfactant and at least one enzyme followed by a first soak period wherein the concentrations of the at least one surfactant and the at least one enzyme are higher relative to their concentrations in a subsequent wash solution;
(b) furthermore adding to the object water to obtain a wash solution followed by a wash period; and
(c) rinsing the object;
wherein said method has a wash performance corresponding to any of (i) a Relative Wash Performance (RWP) of at least 1; (ii) a Process Related Cleaning Index (PRCI) of more than 1; or (iii) a Relative Wash Performance (RWP) of at least 1 and a Process Related Cleaning Index (PRCI) of more than 1.

17. The method of claim 16, wherein no agitation or other mechanical action is applied during the soak period after the initial agitation for the purpose of distributing the soak solution to and wetting of the object.

18. The method of claim 16, wherein agitation or other mechanical action is applied during the wash period.

19. The method of claim 16, wherein the concentration of the at least one enzyme in the wash solution is obtained by diluting the soak solution with a factor of at least 1, 2, 3, 4, 5, 6, 7, 8, 9, 10, 11, 12, 13, 14, 15, 16, 17, 18, 19 or 20.

20. The method of claim 16, wherein the soak period is from 1 to 120 minutes.

21. The method of claim 16, wherein the wash period is from 5 to 120 minutes.

22. The method of claim 16, wherein the temperature during the soak period is below 35° C.

23. The method of claim 16, wherein the temperature during the wash period is below 35° C.

24. The method of claim 16, wherein the at least one enzyme is selected from the group consisting of: hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, beta-glucanases, arabinosidases, hyaluronidases, chondroitinases, laccases, and amylases, or any combination thereof.

25. The method of claim 24, wherein the at least one enzyme is a mixture comprising of an amylase, a cellulase, a lipase and a protease.

26. The method of claim 16, wherein the at least one enzyme may be used at an amount from 0 to 20 milligram enzyme protein per gram textile.

27. The method of claim 16, wherein the at least one surfactant is selected from the group consisting of: anionic surfactants; cationic surfactants; zwitterionic surfactants; amphoteric surfactants: nonionic surfactants; or any combinations thereof.

28. The method of claim 16, wherein the concentration of the at least one surfactant is from 0 to 500 milligram per gram textile.

29. The method of claim 16, wherein the object is fabric/textile.
